(19) United States
(12) Patent Application Publication
(10) Pub. No.: US 2023/0354373 A1
(43) Pub. Date: Nov. 2, 2023

(54) METHOD AND APPARATUS FOR CONFIGURED GRANT REGARDING SIDELINK CARRIER AGGREGATION IN A WIRELESS COMMUNICATION SYSTEM

(71) Applicant: ASUS Technology Licensing Inc., Taipei City (TW)

(72) Inventors: Yi-Hsuan Kung, Taipei City (TW); Chun-Wei Huang, Taipei City (TW); Ming-Che Li, Taipei City (TW); Li-Chih Tseng, Taipei City (TW)

(21) Appl. No.: 18/139,583

(22) Filed: Apr. 26, 2023

Related U.S. Application Data
(60) Provisional application No. 63/335,599, filed on Apr. 27, 2022.

(51) Int. Cl. H04W 72/25; H04W 72/1263; H04W 72/0457; H04W 72/0453

(52) U.S. Cl. CPC H04W 72/25; H04W 72/0453; H04W 72/0457; H04W 72/1263

(57) ABSTRACT

Methods, systems, and apparatuses are provided for configuring sidelink (SL) configured grant configuration in SL carrier aggregation. A method for a first device in a wireless communication system can comprise receiving a first sidelink configured grant configuration, wherein the first sidelink configured grant configuration indicates and/or includes a first frequency information and one or more first SL resources, and performing one or more first SL transmissions via the one or more first SL resources on a first SL frequency indicated by the first frequency information.

### CROSS-REFERENCE TO RELATED APPLICATIONS

The present Application claims priority to and the benefit of U.S. Provisional Pat. Application Serial No. 63/335,599, filed Apr. 27, 2022, which is fully incorporated herein by reference.

### FIELD

This disclosure generally relates to wireless communication networks and, more particularly, to a method and apparatus for configured grant regarding sidelink carrier aggregation in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for configured grant regarding sidelink (SL) carrier aggregation in a wireless communication system. The present invention introduces systems and methods for configuring SL configured grant configuration in SL carrier aggregation.

In various embodiments, a method for a first device in a wireless communication system comprises receiving a first sidelink configured grant configuration, wherein the first sidelink configured grant configuration indicates and/or includes a first frequency information and one or more first SL resources, and performing one or more first SL transmissions via the one or more first SL resources on a first SL frequency indicated by the first frequency information.

In various embodiments, a method for a first device in a wireless communication system comprises receiving a first sidelink frequency configuration, wherein the first sidelink frequency configuration indicates and/or includes at least one first sidelink configured grant configuration, and performing one or more first SL transmissions via one or more first SL resources indicated in the at least one first sidelink configured grant configuration on a first SL frequency indicated in the first frequency configuration.

In various embodiments, a method for a first device in a wireless communication system comprises receiving a first sidelink configuration, wherein the first sidelink configuration indicates and/or includes at least a first SL scheduling configuration associated with a first SL frequency and a second SL scheduling configuration associated with a second SL frequency, performing one or more first SL transmissions via one or more first SL resources, on the first SL frequency, indicated in a first sidelink configured grant configuration in the first SL scheduling configuration, and performing one or more second SL transmissions via one or more second SL resources, on the second SL frequency, indicated in a second sidelink configured grant configuration in the second SL scheduling configuration.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 4.2.2-1: MAC structure overview, from 3GPP 38.321 v17.0.0.

FIG. 6 is a reproduction of FIG. 4.2.2-2: MAC structure overview with two MAC entities, from 3GPP 38.321 v17.0.0.

FIG. 7 is a reproduction of FIG. 4.2.2-3: MAC structure overview for sidelink, from 3GPP 38.321 v17.0.0.

FIG. 8 is a reproduction of FIG. 16.9.1-1: NG-RAN Architecture supporting the PC5 interface, from 3GPP 38.300 v17.0.0.

FIG. 9 is a flow diagram of a first device receiving a first sidelink configured grant configuration and performing a first SL transmission via first SL resource(s), in accordance with embodiments of the present invention.

FIG. 10 is a flow diagram of a first device receiving a first SL frequency configuration and performing one or more SL transmissions via first SL resource(s) indicated in the first list of sidelink configured grant configuration on a first SL frequency indicated in the first SL frequency configuration, in accordance with embodiments of the present invention.

FIG. 11 is a flow diagram of a first device receiving a first sidelink configured grant configuration and performing one or more first SL transmissions via the one or more first SL resources on a first SL frequency indicated by the first frequency information, in accordance with embodiments of the present invention.

FIG. 12 is a flow diagram of a first device receiving a first sidelink SL frequency configuration and performing one or more first SL transmissions via one or more first SL resources indicated in the at least one first SL configured grant configuration on a first SL frequency indicated in the first frequency configuration, in accordance with embodiments of the present invention.

FIG. 13 is a flow diagram of a first device receiving a first SL configuration, performing one or more first SL transmissions via one or more first SL resources, and performing one or more second SL transmissions via one or more second SL resources, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] 3GPP 38.321 v17.0.0; [2] 3GPP 38.331 v17.0.0; [3] 3GPP 38.300 v17.0.0; [4] 3GPP 36.331 v16.0.0; and [5] RP-220300 WID revision: NR sidelink evolution. The standards and documents listed above are hereby expressly and fully incorporated herein by reference in their entirety.

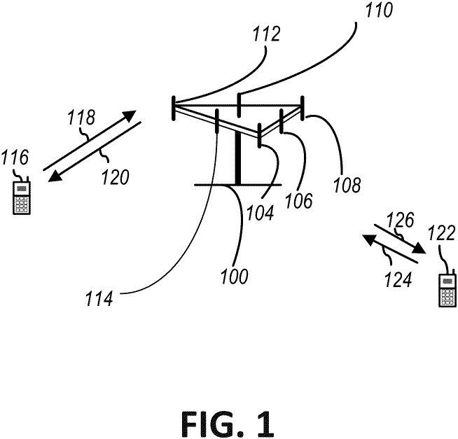

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

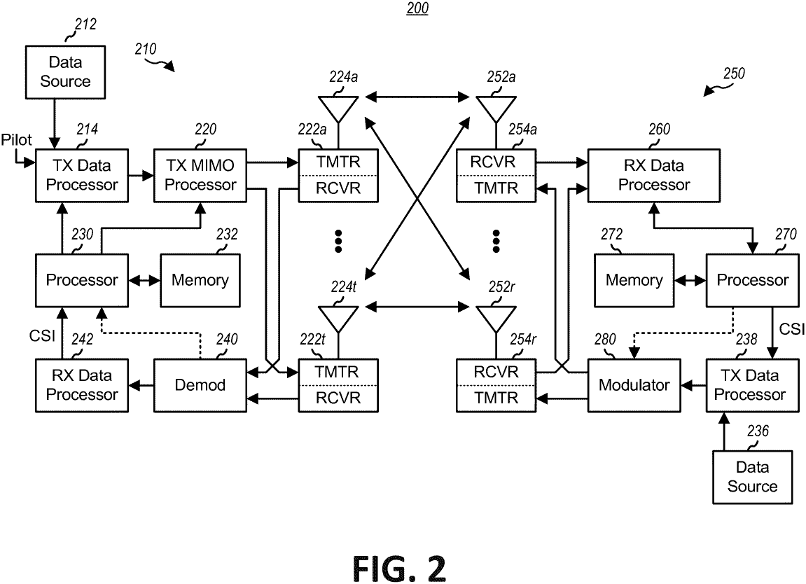

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

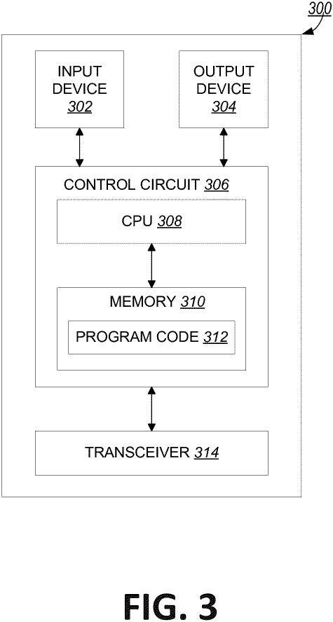

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

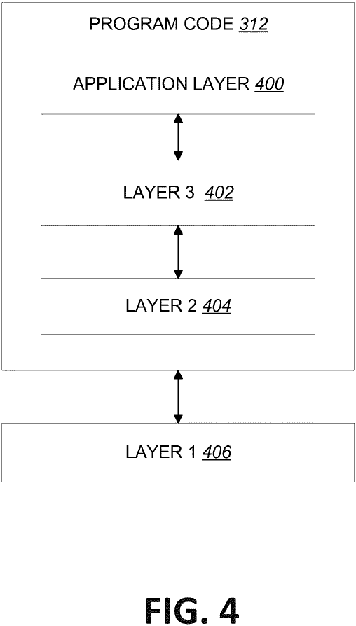

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In the 3GPP specification (e.g., [1] 3GPP 38.321 v17.0.0), MAC architecture, upink and Sidelink transmission/reception are introduced:

### 4.2 MAC Architecture

### 4.2.1 General

This clause describes a model of the MAC i.e. it does not specify or restrict implementations.

RRC is in control of the MAC configuration.

### 4.2.2 MAC Entities

The MAC entity of the UE handles the following transport channels:
Broadcast Channel (BCH);
Downlink Shared Channel(s) (DL-SCH);
Paging Channel (PCH);
Uplink Shared Channel(s) (UL-SCH);
Random Access Channel(s) (RACH).

When the UE is configured with SCG, two MAC entities are configured to the UE: one for the MCG and one for the SCG.

When the UE is configured with DAPS handover, two MAC entities are used by the UE: one for the source cell (source MAC entity) and one for the target cell (target MAC entity).

The functions of the different MAC entities in the UE operate independently unless otherwise specified. The timers and parameters used in each MAC entity are configured independently unless otherwise specified. The Serving Cells, C-RNTI, radio bearers, logical channels, upper and lower layer entities, LCGs, and HARQ entities considered by each MAC entity refer to those mapped to that MAC entity unless otherwise specified.

If the MAC entity is configured with one or more SCells, there are multiple DL-SCH and there may be multiple UL-SCH as well as multiple RACH per MAC entity; one DL-SCH, one UL-SCH, and one RACH on the SpCell, one DL-SCH, zero or one UL-SCH and zero or one RACH for each SCell.

If the MAC entity is not configured with any SCell, there is one DL-SCH, one UL-SCH, and one RACH per MAC entity.

FIG. 4.2.2-1 illustrates one possible structure of the MAC entity when SCG is not configured and for each MAC entity during DAPS handover.

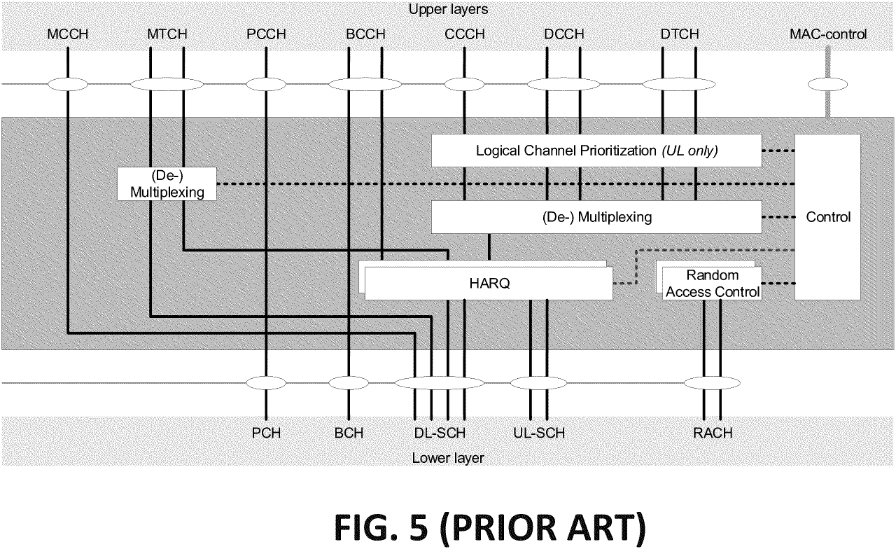

FIG. 5 is a reproduction of FIG. 4.2.2-1: MAC structure overview, from 3GPP 38.321 v17.0.0.

FIG. 4.2.2-2 illustrates one possible structure for the MAC entities when MCG and SCG are configured.

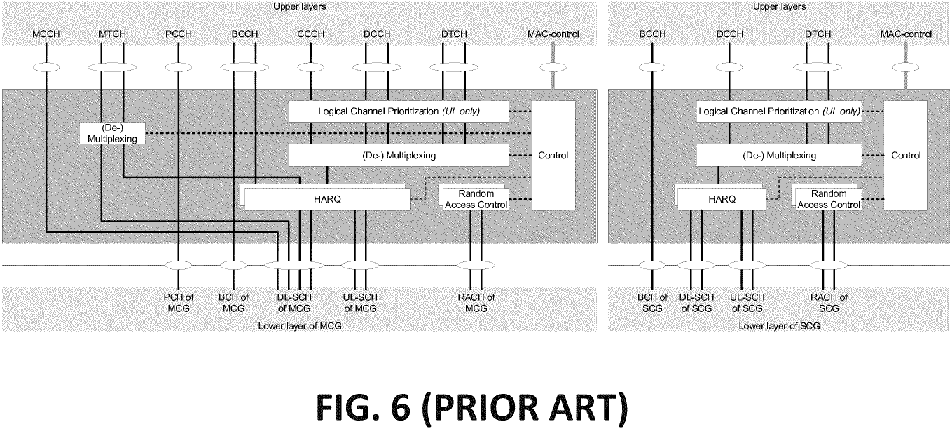

FIG. 6 is a reproduction of FIG. 4.2.2-2: MAC structure overview with two MAC entities, from 3GPP 38.321 v17.0.0.

In addition, the MAC entity of the UE handles the following transport channel for sidelink:
Sidelink Shared Channel (SL-SCH);
Sidelink Broadcast Channel (SL-BCH).

FIG. 4.2.2-3 illustrates one possible structure for the MAC entity when sidelink is configured.

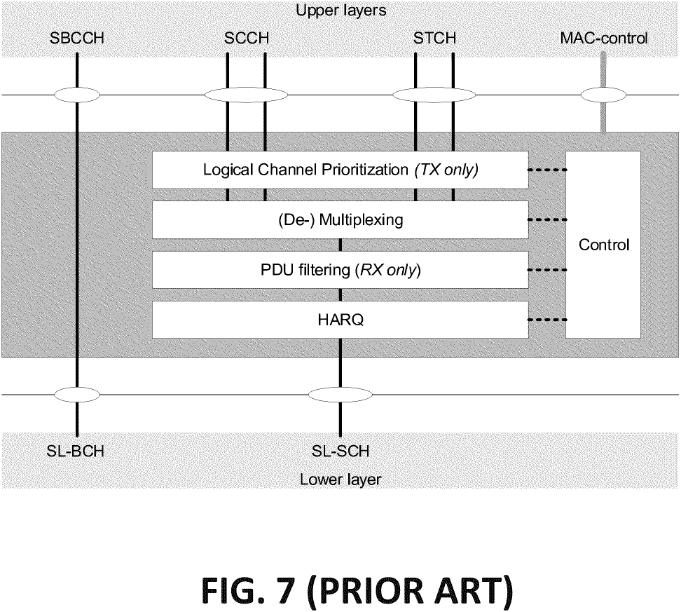

FIG. 7 is a reproduction of FIG. 4.2.2-3: MAC structure overview for sidelink, from 3GPP 38.321 v17.0.0.

### 5.4 UL-SCH Data Transfer

### 5.4.1 UL Grant Reception

Uplink grant is either received dynamically on the PDCCH, in a Random Access Response, configured semi-persistently by RRC or determined to be associated with the PUSCH resource of MSGA as specified in clause 5.1.2a. The MAC entity shall have an uplink grant to transmit on the UL-SCH. To perform the requested transmissions, the MAC layer receives HARQ information from lower layers. An uplink grant addressed to CS-RNTI with NDI = 0 is considered as a configured uplink grant. An uplink grant addressed to CS-RNTI with NDI = 1 is considered as a dynamic uplink grant.

If the MAC entity has a C-RNTI, a Temporary C-RNTI, or CS-RNTI, the MAC entity shall for each PDCCH occasion and for each Serving Cell belonging to a TAG that has a running timeAlignmentTimer or a running cg-SDT-TimeAlignmentTimer and for each grant received for this PDCCH occasion:
1> if an uplink grant for this Serving Cell has been received on the PDCCH for the MAC entity’s C-RNTI or Temporary C-RNTI; or
1> if an uplink grant has been received in a Random Access Response:
   2> if the uplink grant is for MAC entity’s C-RNTI and if the previous uplink grant delivered to the HARQ entity for the same HARQ process was either an uplink grant received for the MAC entity’s CS-RNTI or a configured uplink grant:
      3> consider the NDI to have been toggled for the corresponding HARQ process regardless of the value of the NDI.
   2> if the uplink grant is for MAC entity’s C-RNTI, and the identified HARQ process is configured for a configured uplink grant:
      3> start or restart the configuredGrantTimer for the corresponding HARQ process, if configured;
      3> stop the cg-SDT-RetransmissionTimer for the corresponding HARQ process, if running;
      3> stop the cg-RetransmissionTimer for the corresponding HARQ process, if running.
   2> deliver the uplink grant and the associated HARQ information to the HARQ entity.
1> else if an uplink grant for this PDCCH occasion has been received for this Serving Cell on the PDCCH for the MAC entity’s CS-RNTI:
   2> if the NDI in the received HARQ information is 1:
      3> consider the NDI for the corresponding HARQ process not to have been toggled;
      3> start or restart the configuredGrantTimer for the corresponding HARQ process, if configured;
      3> stop the cg-RetransmissionTimer for the corresponding HARQ process, if running;
      3> stop the cg-SDT-RetransmissionTimer for the corresponding HARQ process, if running;
      3> deliver the uplink grant and the associated HARQ information to the HARQ entity;
      3> if a logical channel associated with a DRB configured with survivalTimeStateSupport is multiplexed in the MAC PDU stored in the HARQ buffer for the corresponding HARQ process:
         4> trigger activation of PDCP duplication for all configured RLC entities of the DRB.
   2> else if the NDI in the received HARQ information is 0:
      3> if PDCCH contents indicate configured grant Type 2 deactivation:
         4> trigger configured uplink grant confirmation.
      3> else if PDCCH contents indicate configured grant Type 2 activation:
         4> trigger configured uplink grant confirmation;
         4> store the uplink grant for this Serving Cell and the associated HARQ information as configured uplink grant;
         4> initialise or re-initialise the configured uplink grant for this Serving Cell to start in the associated PUSCH duration and to recur according to rules in clause 5.8.2;
         4> stop the configuredGrantTimer for the corresponding HARQ process, if running;
         4> stop the cg-RetransmissionTimer for the corresponding HARQ process, if running.

For each Serving Cell and each configured uplink grant, if configured and activated, the MAC entity shall:
1> if the MAC entity is configured with lch-basedPrioritization, and the PUSCH duration of the configured uplink grant does not overlap with the PUSCH duration of an uplink grant received in a Random Access Response or with the PUSCH duration of an uplink grant addressed to Temporary C-RNTI or the PUSCH duration of a MSGA payload for this Serving Cell; or
1> if the MAC entity is not configured with lch-basedPrioritization, and the PUSCH duration of the configured uplink grant does not overlap with the PUSCH duration of an uplink grant received on the PDCCH or in a Random Access Response or the PUSCH duration of a MSGA payload for this Serving Cell:
   2> set the HARQ Process ID to the HARQ Process ID associated with this PUSCH duration;
   2> if, for the corresponding HARQ process, the configuredGrantTimer is not running and cg-RetransmissionTimer is not configured and cg-SDT-RetransmissionTimer is not configured (i.e. new transmission):
      3> consider the NDI bit for the corresponding HARQ process to have been toggled;
      3> deliver the configured uplink grant and the associated HARQ information to the HARQ entity.
   2> else if the cg-RetransmissionTimer for the corresponding HARQ process is configured and not running, then for the corresponding HARQ process:
      3> if the configuredGrantTimer is not running, and the HARQ process is not pending (i.e. new transmission):
         4> consider the NDI bit to have been toggled;
         4> deliver the configured uplink grant and the associated HARQ information to the HARQ entity.
      3> else if the previous uplink grant delivered to the HARQ entity for the same HARQ process was a configured uplink grant (i.e. retransmission on configured grant):
         4> deliver the configured uplink grant and the associated HARQ information to the HARQ entity.

For configured uplink grants neither configured with harq-ProcID-Offset2 nor with cg-RetransmissionTimer, the HARQ Process ID associated with the first symbol of a UL transmission is derived from the following equation:

HARQ Process ID = [floor(CURRENT_symbol/periodicity)] modulo nrofHARQ-Processes

For configured uplink grants with harq-ProcID-Offset2, the HARQ Process ID associated with the first symbol of a UL transmission is derived from the following equation:

HARQ Process ID = [floor(CURRENT_symbol / periodicity)] modulo nrofHARQ-Processes + harq-ProcID-Offset2

where CURRENT_symbol = (SFN × numberOfSlotsPerFrame × numberOfSymbolsPerSlot + slot number in the frame × numberOfSymbolsPerSlot + symbol number in the slot), and numberOfSlotsPerFrame and numberOfSymbolsPerSlot refer to the number of consecutive slots per frame and the number of consecutive symbols per slot, respectively as specified in TS 38.211 [8].

### 5.8 Transmission and Reception Without Dynamic Scheduling

### 5.8.2 Uplink

There are two types of transmission without dynamic grant:
configured grant Type 1 where an uplink grant is provided by RRC, and stored as configured uplink grant;
configured grant Type 2 where an uplink grant is provided by PDCCH, and stored or cleared as configured uplink grant based on L1 signalling indicating configured uplink grant activation or deactivation.

Type 1 and Type 2 are configured by RRC for a Serving Cell per BWP. Multiple configurations can be active simultaneously in the same BWP. For Type 2, activation and deactivation are independent among the Serving Cells. For the same BWP, the MAC entity can be configured with both Type 1 and Type 2.

Only configured grant Type 1 can be configured for CG-SDT. CG-SDT can only be configured on initial BWP.

RRC configures the following parameters when the configured grant Type 1 is configured:
cs-RNTI: CS-RNTI for retransmission;
cg-SDT-RSRP-ThresholdSSB: an RSRP threshold configured for SSB selection for CG-SDT;
periodicity: periodicity of the configured grant Type 1;
timeDomainOffset: Offset of a resource with respect to SFN = timeReferenceSFN in time domain;
timeDomainAllocation: Allocation of configured uplink grant in time domain which contains startSymbolAndLength (i.e. SLIV in TS 38.214 ) or startSymbol (i.e. S in TS 38.214 );
nrofHARQ-Processes: the number of HARQ processes for configured grant;
harq-ProcID-Offset: offset of HARQ process for configured grant configured with cg-RetransmissionTimer for operation with shared spectrum channel access;
harq-ProcID-Offset2: offset of HARQ process for configured grant not configured with cg-RetransmissionTimer;
timeReferenceSFN: SFN used for determination of the offset of a resource in time domain. The UE uses the closest SFN with the indicated number preceding the reception of the configured grant configuration.

RRC configures the following parameters when the configured grant Type 2 is configured:
cs-RNTI: CS-RNTI for activation, deactivation, and retransmission;
periodicity: periodicity of the configured grant Type 2;
nrofHARQ-Processes: the number of HARQ processes for configured grant;
harq-ProcID-Offset: offset of HARQ process for configured grant configured with cg-RetransmissionTimer for operation with shared spectrum channel access;
harq-ProcID-Offset2: offset of HARQ process for configured grant not configured with cg-RetransmissionTimer.

RRC configures the following parameter when retransmissions on configured uplink grant is configured:
cg-RetransmissionTimer: the duration after a configured grant (re)transmission of a HARQ process when the UE shall not autonomously retransmit that HARQ process.

Upon configuration of a configured grant Type 1 for a BWP of a Serving Cell by upper layers, the MAC entity shall:
1> store the uplink grant provided by upper layers as a configured uplink grant for the indicated BWP of the Serving Cell;
1> initialise or re-initialise the configured uplink grant to start in the symbol according to timeDomainOffset, timeReferenceSFN, and S (derived from SLIV or provided by startSymbol as specified in TS 38.214 [7]), and to reoccur with periodicity.

After an uplink grant is configured for a configured grant Type 1, the MAC entity shall consider sequentially that the N^{th} (N >= 0) uplink grant occurs in the symbol for which:

[(SFN × numberOfSlotsPerFrame × numberOfSymbolsPerSlot) + (slot number in the frame × numberOfSymbolsPerSlot) + symbol number in the slot] = (timeReferenceSFN × numberOfSlotsPerFrame × numberOfSymbolsPerSlot + timeDomainOffset × numberOfSymbolsPerSlot + S + N × periodicity) modulo (1024 × numberOfSlotsPerFrame × numberOfSymbolsPerSlot).

For an uplink grant configured for configured grant Type 1 for CG-SDT on the selected uplink carrier as in clause 5.27, when CG-SDT is triggered and not terminated, for each configured grant valid according to TS 38.214 [7] for which the above formula is satisfied, the MAC entity shall:
1> if at least one SSB configured for CG-SDT with SS-RSRP above cg-SDT-RSRP-ThresholdSSB is available:
   2> if after initial transmission for CG-SDT with CCCH message has been performed according to clause 5.4.1, PDCCH addressed to the MAC entity’s C-RNTI has been received, and the SSB corresponding to the configured UL grant has the same SSB index as the SSB selected for initial transmission for CG-SDT with CCCH message (i.e., SSB for retransmission of initial transmission of CG-SDT); or
   2> if the RSRP of the SSB corresponding to the configured uplink grant is above the cg-SDT-RSRP-ThresholdSSB: (i.e., SSB for initial and subsequent new CG-SDT transmission):
      3> indicate the SSB index corresponding to the configured uplink grant to the lower layer;
      3> consider this configured uplink grant as valid.
1> else:
   2> initiate Random Access procedure in clause 5.1.

After an uplink grant is configured for a configured grant Type 2, the MAC entity shall consider sequentially that the N^{th} (N >= 0) uplink grant occurs in the symbol for which:

[(SFN × numberOfSlotsPerFrame × numberOfSymbolsPerSlot) + (slot number in the frame × numberOfSymbolsPerSlot) + symbol number in the slot] = [(SFNstart ₜᵢₘₑ × numberOfSlotsPerFrame × numberOfSymbolsPerSlot + slotstart ₜᵢₘₑ × numberOfSymbolsPerSlot + symbolₛₜₐᵣₜ ₜᵢₘₑ) + N × periodicity] modulo (1024 × numberOfSlotsPerFrame × numberOfSymbolsPerSlot).

where SFNₛₜₐᵣₜ ₜᵢₘₑ, slot_{start time}, and symbol_{start time} are the SFN, slot, and symbol, respectively, of the first transmission opportunity of PUSCH where the configured uplink grant was (re-)initialised.

If cg-nrofPUSCH-InSlot or cg-nrofSlots is configured for a configured grant Type 1 or Type 2, the MAC entity shall consider the uplink grants occur in those additional PUSCH allocations as specified in clause 6.1.2.3 of TS 38.214 [7].

NOTE: In case of unaligned SFN across carriers in a cell group, the SFN of the concerned Serving Cell is used to calculate the occurrences of configured uplink grants.

When the configured uplink grant is released by upper layers, all the corresponding configurations shall be released and all corresponding uplink grants shall be cleared.

The MAC entity shall:
1> if at least one configured uplink grant confirmation has been triggered and not cancelled; and
1> if the MAC entity has UL resources allocated for new transmission:
2> if, in this MAC entity, at least one configured uplink grant is configured by configuredGrantConfigToAddModList:
   3> instruct the Multiplexing and Assembly procedure to generate a Multiple Entry Configured Grant Confirmation MAC CE as defined in clause 6.1.3.31.
2> else:
   3> instruct the Multiplexing and Assembly procedure to generate a Configured Grant Confirmation MAC CE as defined in clause 6.1.3.7.
2> cancel all triggered configured uplink grant confirmation(s).

For a configured grant Type 2, the MAC entity shall clear the configured uplink grant(s) immediately after first transmission of Configured Grant Confirmation MAC CE or Multiple Entry Configured Grant Confirmation MAC CE which confirms the configured uplink grant deactivation.

Retransmissions use:
repetition of configured uplink grants; or
received uplink grants addressed to CS-RNTI; or
configured uplink grants with cg-RetransmissionTimer configured.

### 5.8.3 Sidelink

There are two types of transmission without dynamic sidelink grant:
configured grant Type 1 where an sidelink grant is provided by RRC, and stored as configured sidelink grant;
configured grant Type 2 where an sidelink grant is provided by PDCCH, and stored or cleared as configured sidelink grant based on L1 signalling indicating configured sidelink grant activation or deactivation.

Type 1 and/or Type 2 are configured with a single BWP. Multiple configurations of up to 8 configured grants (including both Type 1 and Type 2, if configured) can be active simultaneously on the BWP.

RRC configures the following parameters when the configured grant Type 1 is configured, as specified in TS 38.331 [5] or TS 36.331 [21]:
sl-ConfigIndexCG: the identifier of a configured grant for sidelink;
sl-CS-RNTI: SLCS-RNTI for retransmission;
sl-NrOfHARQ-Processes: the number of HARQ processes for configured grant;
sl-PeriodCG: periodicity of the configured grant Type 1;
sl-TimeOffsetCG-Type1: Offset of a resource with respect to reference logical slot defined by sl-TimeReferenceSFN-Type1 in time domain, referring to the number of logical slots in a resource pool;
sl-TimeResourceCG-Type1: time resource location of the configured grant Type 1;
sl-CG-MaxTransNumList: the maximum number of times that a TB can be transmitted using the configured grant;
sl-HARQ-ProcID-offset: offset of HARQ process for configured grant Type 1;
sl-TimeReferenceSFN-Type1: SFN used for determination of the offset of a resource in time domain. If it is present, the UE uses the first logical slot of associated resource pool after the starting time of the closest SFN with the indicated number preceding the reception of the sidelink configured grant configuration Type 1 as reference logical slot. If it is absent, the indicated reference SFN is zero.

RRC configures the following parameters when the configured grant Type 2 is configured, as specified in TS 38.331 [5]:
sl-ConfigIndexCG: the identifier of a configured grant for sidelink;
sl-CS-RNTI: SLCS-RNTI for activation, deactivation, and retransmission;
sl-NrOfHARQ-Processes: the number of HARQ processes for configured grant;
sl-PeriodCG: periodicity of the configured grant Type 2;
sl-CG-MaxTransNumList: the maximum number of times that a TB can be transmitted using the configured grant;
sl-HARQ-ProcID-offset: offset of HARQ process for configured grant Type 2.

Upon configuration of a configured grant Type 1, the MAC entity shall for each configured sidelink grant:
1> store the sidelink grant provided by RRC as a configured sidelink grant;
1> initialise or re-initialise the configured sidelink grant to determine PSCCH duration(s) and PSSCH duration(s) according to sl-TimeOffsetCG-Typel and sl-TimeResourceCG-Typel, and to reoccur with sl-periodCG for transmissions of multiple MAC PDUs according to clause 8.1.2 of TS 38.214 [7].

NOTE 1: If the MAC entity is configured with multiple configured sidelink grants, collision among the configured sidelink grants may occur. How to handle the collision is left to UE implementation.

After a sidelink grant is configured for a configured grant Type 1, the MAC entity shall consider sequentially that the first slot of the S^{th} sidelink grant occurs in the logical slot for which:

CURRENT_slot = (sl-ReferenceSlotCG-Type1 + sl-TimeOffsetCG-Type1 + S × PeriodicitySL) modulo T′ₘₐₓ where CURRENT_slot refers to current logical slot in the associated resource pool, PeriodicitySL =

$$\left⌈\frac{{}_{}^{T}{\text{'}} m a x}{\text{10240} m s} \times s l \text{-} P e r i o d C G\right⌉$$

and T′ₘₐₓ is the number of slots that belongs to the associated resource pool as defined in clause 8 of TS 38.214[7]. sl-ReferenceSlotCG-Type1 refers to reference logical slot defined by sl-TimeReferenceSFN-Type1.

After a sidelink grant is configured for a configured grant Type 2, the MAC entity shall consider sequentially that the first slot of S^{th} sidelink grant occurs in the logical slot for which:

CURRENT_slot = (sl-StartSlotCG-Type2 + S × PeriodicitySL) modulo T′ₘₐₓ

where sl-StartSlotCG-Type2 refers to the logical slot of the first transmission opportunity of PSSCH where the configured sidelink grant was (re)initialised.

When a configured sidelink grant is released by RRC, all the corresponding configurations shall be released and all corresponding sidelink grants shall be cleared.

The MAC entity shall:
1> if the configured sidelink grant confirmation has been triggered and not cancelled; and
1> if the MAC entity has UL resources allocated for new transmission:
   2> instruct the Multiplexing and Assembly procedure to generate a Sidelink Configured Grant Confirmation MAC CE as defined in clause 6.1.3.34;
   2> cancel the triggered configured sidelink grant confirmation.

For a configured grant Type 2, the MAC entity shall clear the corresponding configured sidelink grant immediately after first transmission of Sidelink Configured Grant Confirmation MAC CE triggered by the configured sidelink grant deactivation.

### 5.22.1 SL-SCH Data Transmission

### 5.22.1.1 SL Grant Reception and SCI Transmission

Sidelink grant is received dynamically on the PDCCH, configured semi-persistently by RRC or autonomously selected by the MAC entity. The MAC entity shall have a sidelink grant on an active SL BWP to determine a set of PSCCH duration(s) in which transmission of SCI occurs and a set of PSSCH duration(s) in which transmission of SL-SCH associated with the SCI occurs. A sidelink grant addressed to SLCS-RNTI with NDI = 1 is considered as a dynamic sidelink grant.

If the MAC entity has been configured with Sidelink resource allocation mode 1 as indicated in TS 38.331 [5], the MAC entity shall for each PDCCH occasion and for each grant received for this PDCCH occasion:
1> if a sidelink grant has been received on the PDCCH for the MAC entity’s SL-RNTI:
   2> if the NDI received on the PDCCH has not been toggled compared to the value in the previously received HARQ information for the HARQ Process ID:
      3> use the received sidelink grant to determine PSCCH duration(s) and PSSCH duration(s) for one or more retransmissions of a single MAC PDU for the corresponding Sidelink process according to clause 8.1.2 of TS 38.214 [7].
   2> else:
      3> use the received sidelink grant to determine PSCCH duration(s) and PSSCH duration(s) for initial transmission and, if available, retransmission(s) of a single MAC PDU according to clause 8.1.2 of TS 38.214 [7].
   2> if a sidelink grant is available for retransmission(s) of a MAC PDU which has been positively acknowledged as specified in clause 5.22.1.3.1a:
      3> clear the PSCCH duration(s) and PSSCH duration(s) corresponding to retransmission(s) of the MAC PDU from the sidelink grant.
1> else if a sidelink grant has been received on the PDCCH for the MAC entity’s SLCS-RNTI:
   2> if PDCCH contents indicate retransmission(s) for the identifed HARQ process ID that has been set for an activated configured sidelink grant identified by sl-ConfigIndexCG:
      3> use the received sidelink grant to determine PSCCH duration(s) and PSSCH duration(s) for one or more retransmissions of a single MAC PDU according to clause 8.1.2 of TS 38.214 [7].
   2> else if PDCCH contents indicate configured grant Type 2 deactivation for a configured sidelink grant:
      3> trigger configured sidelink grant confirmation for the configured sidelink grant.
   2> else if PDCCH contents indicate configured grant Type 2 activation for a configured sidelink grant:
      3> trigger configured sidelink grant confirmation for the configured sidelink grant;
      3> store the configured sidelink grant;
      3> initialise or re-initialise the configured sidelink grant to determine the set of PSCCH durations and the set of PSSCH durations for transmissions of multiple MAC PDUs according to clause 8.1.2 of TS 38.214 [7].

... In the 3GPP specification 38.331 (e.g., [2] 3GPP 38.331 v17.0.0), Sidelink frequency and Uu/SL Configured grant configurations are introduced:

### RRCReconfiguration

The RRCReconfiguration message is the command to modify an RRC connection. It may convey information for measurement configuration, mobility control, radio resource configuration (including RBs, MAC main configuration and physical channel configuration) and AS security configuration.
Signalling radio bearer: SRB1 or SRB3
RLC-SAP: AM
Logical channel: DCCH Direction: Network to UE

### RRCRECONFIGURATION MESSAGE

-- ASN1START
-- TAG-RRCRECONFIGURATION-START
RRCReconfiguration ::= SEQUENCE {
rrc-TransactionIdentifier RRC-TransactionIdentifier,
criticalExtensions CHOICE {
rrcReconfiguration RRCReconfiguration-IEs,
criticalExtensionsFuture SEQUENCE { }
}
}
RRCReconfiguration-v1530-IEs ::= SEQUENCE {
masterCellGroup OCTET STRING (CONTAINING CellGroupConfig)
OPTIONAL, -- Need M
fullConfig ENUMERATED {true}
OPTIONAL, -- Cond FullConfig
...
sl-ConfigDedicatedNR-r16 SetupRelease (SL-ConfigDedicatedNR-r16}
OPTIONAL, -- Need M
sl-ConfigDedicatedEUTRA-Info-r16 SetupRelease {SL-ConfigDedicatedEUTRA-Info-r16}
OPTIONAL, -- Need M
}
...
SL-ConfigDedicatedEUTRA-Info-r16 ::= SEQUENCE {
sl-ConfigDedicatedEUTRA-r16 OCTET STRING
OPTIONAL, -- Need M
sl-TimeOffsetEUTRA-List-r16 SEQUENCE (SIZE (8)) OF SL-TimeOffsetEUTRA-r16
OPTIONAL -- Need M
}
SL-TimeOffsetEUTRA-r16 ::=ENUMERATED {ms0, ms0dot25, ms0dot5, ms0dot625, ms0dot75, ms1,
msldot25, msldot5, msldot75,
ms2, ms2dot5, ms3, ms4, ms5, ms6, ms8, ms10, ms20}
-- TAG-RRCRECONFIGURATION-STOP
-- ASN1STOP

### RRCReconfiguration-IEs Field Descriptions

### SL-ConfigDedicatedNR

This field is used to provide the dedicated configurations for NR sidelink communication/discovery.

### SL-ConfigDedicatedEUTRA-Info

This field includes the E-UTRA RRCConnectionReconfiguration as specified in TS 36.331 [10]. In this version of the specification, the E-UTRA RRCConnectionReconfiguration can only includes sidelink related fields for V2X sidelink communication, i.e. sl-V2X-ConfigDedicated, sl-V2X-SPS-Config, measConfig and/or otherConfig.

### - SL-ConfigDedicatedNR

The IE SL-ConfigDedicatedNR specifies the dedicated configuration information for NR sidelink communication.

### SL-CONFIGDEDICATEDNR INFORMATION ELEMENT

SL-ConfigDedicatedNR-r16 ::= SEQUENCE {
sl-PHY-MAC-RLC-Config-r16 SL-PHY-MAC-RLC-Config-r16 OPTIONAL, -- Need M
sl-RadioBearerToReleaseList-r16 SEQUENCE (SIZE (1..maxNrofSLRB-r16)) OF SLRB-Uu-ConfigIndex-
r16 OPTIONAL, -- Need N
sl-RadioBearerToAddModList-r16 SEQUENCE (SIZE (1..maxNrofSLRB-r16)) OF SL-
RadioBearerConfig-r16 OPTIONAL, -- Need N
sl-MeasConfigInfoToReleaseList-r16 SEQUENCE (SIZE (1..rnaxNrofSL-Dest-r16)) OF SL-
DestinationIndex-r16 OPTIONAL, -- Need N
sl-MeasConfigInfoToAddModList-r16 SEQUENCE (SIZE (1..maxNrofSL-Dest-r16)) OF SL-
MeasConfigInfo-r16 OPTIONAL, -- Need N
t400-r16 ENUMERATED {ms100, ms200, ms300, ms400, ms600, ms1000,
ms1500, ms2000} OPTIONAL, -- Need M
...,
[[
sl-PHY-MAC-RLC-Config-v1700 SL-PHY-MAC-RLC-Config-v1700
OPTIONAL, -- Need M
sl-DiscConfig-r17 SetupRelease {SL-DiscConfig-r17}
OPTIONAL, -- Need M
sl-RLC-ChannelToReleaseList-r17 SEQUENCE (SIZE (1..maxSL-LCID-r16)) OF SL-RLC-ChannelID-r17
OPTIONAL, -- Cond L2U2N
sl-RLC-ChannelToAddModList-r17 SEQUENCE (SIZE (1..maxSL-LCID-r16)) OF SL-RLC-ChannelConfig-
r17 OPTIONAL -- Cond L2U2N
]]
}
SL-DestinationIndex-r16 ::= INTEGER (0..maxNrofSL-Dest-1-r16)
SL-PHY-MAC-RLC-Config-r16::= SEQUENCE {
sl-ScheduledConfig-r16 SetupRelease { SL-ScheduledConfig-r16 }
OPTIONAL, -- Need M
sl-UE-SelectedConfig-r16 SetupRelease { SL-UE-SelectedConfig-r16 }
OPTIONAL, -- Need M
sl-FreqInfoToReleaseList-r16 SEQUENCE (SIZE (1..maxNrofFreqSL-r16)) OF SL-Freq-Id-r16
OPTIONAL, -- Need N
sl-FreqInfoToAddModList-r16 SEQUENCE (SIZE (1..maxNrofFreqSL-r16)) OF SL-FreqConfig-r16
OPTIONAL, -- Need N
sl-RLC-BearerToReleaseList-r16 SEQUENCE (SIZE (1..rnaxSL-LCID-r16)) OF SL-RLC-
BearerConfigIndex-rl6 OPTIONAL, -- Need N
sl-RLC-BearerToAddModList-r16 SEQUENCE (SIZE (1..maxSL-LCID-r16)) OF SL-RLC-BearerConfig-
r16 OPTIONAL, -- Need N
sl-MaxNumConsecutiveDTX-r16 ENUMERATED {n1, n2, n3, n4, n6, n8, n16, n32}
OPTIONAL, -- Need M
sl-CSI-Acquisition-r16 ENUMERATED {enabled}
OPTIONAL, -- Need R
sl-CSI-SchedulingRequestId-r16 SetupRelease {SchedulingRequestId}
OPTIONAL, -- Need M
sl-SSB-PriorityNR-r16 INTEGER (1..8)
OPTIONAL, -- Need R
networkControlledSyncTx-r16 ENUMERATED {on, off}
OPTIONAL -- Need M
}
SL-PHY-MAC-RLC-Config-v1700 ::= SEQUENCE {
sl-DRX-Config-r17 SetupRelease { SL-DRX-Config-r17 }
OPTIONAL , -- Need M
...
}
SL-DiscConfig-r17::= SEQUENCE {
sl-RelayUE-Config-r17 SetupRelease { SL-RelayUE-Config-r17}
OPTIONAL, -- L2RelayUE
sl-RemoteUE-Config-r17 SetupRelease { SL-RemoteUE-Config-r17}
OPTIONAL -- L2RemoteUE
}

### SL-ConfigDedicatedNR Field Descriptions

### SL-MeasConfigInfoToAddModList

This field indicates the RSRP measurement configurations for unicast destinations to add and/or modify.

### SL-MeasConfiglnfoToReleaseList

This field indicates the RSRP measurement configurations for unicast destinations to remove.

### SL-PHY-MAC-RLC-Config

This field indicates the lower layer sidelink radio bearer configurations.

### SL-RadioBearerToAddModLisf

This field indicates one or multiple sidelink radio bearer configurations to add and/or modify. This field is not configured to the PC5 connection used for L2 U2N relay operation.

### SL-RadioBearerToReleaseList

This field indicates one or multiple sidelink radio bearer configurations to remove. This field is not configured to the PC5 connection used for L2 U2N relay operation.

### SL-PHY-MAC-RLC-Configfield Descriptions

### SL-DRX-Config

This field indicates the sidelink DRX configuration(s) for unicast, groupcast and/or broadcast communication, as specified in TS 38.321 [3].

### SL-FreqlnfoToAddModList

This field indicates the NR sidelink communication configuration on some carrier frequency (ies) to add and/or modify. In this release, only one entry can be configured in the list.

### SL-FreqlnfoToReleaseList

This field indicates the NR sidelink communication configuration on some carrier frequency (ies) to remove. In this release, only one entry can be configured in the list.

### SL-ScheduledConfig

Indicates the configuration for UE to transmit NR sidelink communication based on network scheduling. This field is not configured simultaneously with sl-UE-SelectedConfig. This field is not configured to a L2 U2N Remote UE.

### SL_UE_SelectedConfig

Indicates the configuration used for UE autonomous resource selection. This field is not configured simultaneously with sl-ScheduledConfig.

### - SL-ScheduledConfig

The IE SL-ScheduledConfig specifies sidelink communication configurations used for network scheduled NR sidelink communication.

### SL-SCHEDULEDCONFIG INFORMATION ELEMENT

-- ASN1START
-- TAG-SL-SCHEDULEDCONFIG-START
SL-ScheduledConfig-r16 ::= SEQUENCE {
sl-RNTI-r16 RNTI-Value,
mac-MainConfigSL-r16 MAC-MainConfigSL-r16
OPTIONAL, - Need M
sl-CS-RNTI-r16 RNTI-Value
OPTIONAL, -- Need M
sl-PSFCH-ToPUCCH-r16 SEQUENCE (SIZE (1..8)) OF INTEGER (0..15)
OPTIONAL, -- Need M
sl-ConfiguredGrantConfigList-r16 SL-ConfiguredGrantConfigList-r16
OPTIONAL, -- Need M
[[.,
sl-DCI-ToSL-Trans-r16 SEQUENCE (SIZE (1..8)) OF INTEGER (1..32)
OPTIONAL -- Need M
]]
}
MAC-MainConfigSL-r16 ::= SEQUENCE {
sl-BSR-Config-r16 BSR-Config
OPTIONAL, -- Need M
ul-PrioritizationThres-r16 INTEGER (1..16)
OPTIONAL, -- Need M
sl-PrioritizationThres-r16 INTEGER (1..8)
OPTIONAL, -- Need M
...
}
SL-ConfiguredGrantConfigList-r16 ::= SEQUENCE {
sl-ConfiguredGrantConfigToReleaseList-r16 SEQUENCE (SIZE (1..maxNrofCG-SL-r16)) OF SL-
ConfigIndexCG-r16 OPTIONAL, -- Need N
sl-ConfiguredGrantConfigToAddModList-r16 SEQUENCE (SIZE (1..maxNrofCG-SL-r16)) OF SL-
ConfiguredGrantConfig-r16 OPTIONAL -- Need N
}
-- TAG-SL-SCHEDULEDCONFIG-STOP
-- ASN1STOP

### SL-ScheduledConfigfield Descriptions

Indicate the RNTI used to scramble CRC of DCI format 3_0, see TS 38.321 [3].

### SL-DCI-ToSL-Trans

Indicate the time gap between DCI reception and the first sidelink transmission scheduled by the DCI (see TS 38.214 [19], clause 8.1.2.1). Value 1 included in this field corresponds to 1 slot, value 2 corresponds to 2 slots and so on, based on the numerology of sidelink BWP.

### SL-PSFCH-ToPUCCH

For dynamic grant and configured grant type 2, this field configures the values of the PSFCH to PUCCH gap. The field PSFCH-to-HARQ_ feedback timing indicator in DCI format 3_0 selects one of the configured values of the PSFCH to PUCCH gap.

### SL-RNTI

Indicate the C-RNTI used for monitoring the network scheduling to transmit NR sidelink communication (i.e. the mode 1).

### SL-ConfiguredGrantConfig

The IE SL-ConfiguredGrantConfig specifies the configured grant configuration information for NR sidelink communication.

### SL-CONFIGUREDGRANTCONFIG INFORMATION ELEMENT

--ASN1START
--TAG-SL-CONFIGUREDGRANTCONFIG-START
SL-ConfiguredGrantConfig-r16 ::= SEQUENCE {
sl-ConfigIndexCG-r16 SL-ConfigIndexCG-r16,
sl-PeriodCG-r16 SL-PeriodCG-r16
OPTIONAL, -- Need M
sl-NrOfHARQ-Processes-r16 INTEGER (1..16)
OPTIONAL, -- Need M
sl-HARQ-ProcID-offset-r16 INTEGER (0..15)
OPTIONAL, -- Need M
sl-CG-MaxTransNumList-r16 SL-CG-MaxTransNumList-r16
OPTIONAL, -- Need M
rrc-ConfiguredSidelinkGrant-r16 SEQUENCE {
sl-TimeResourceCG-Type1-r16 INTEGER (0..496)
OPTIONAL, -- Need M
sl-StartSubchannelCG-Type1-r16 INTEGER (0..26)
OPTIONAL, -- Need M
sl-FreqResourceCG-Type1-r16 INTEGER (0..6929)
OPTIONAL, -- Need M
sl-TimeOffsetCG-Type1-r16 INTEGER (0..7999)
OPTIONAL, -- Need R
sl-N1PUCCH-AN-r16 PUCCH-ResourceId
OPTIONAL, -- Need M
sl-PSFCH-ToPUCCH-CG-Type1-r16 INTEGER (0..15)
OPTIONAL, -- Need M
sl-ResourcePoolID-r16 SL-ResourcePoolID-r16
OPTIONAL, -- Need M
sl-TimeReferenceSFN-Type1-r16 ENUMERATED {sfn512)
OPTIONAL -- Need S
}
OPTIONAL, -- Need M
...,
[[
sl-N1PUCCH-AN-Type2-r16 PUCCH-ResourceId
OPTIONAL -- Need M
]]
}
SL-ConfigIndexCG-r16 ::= INTEGER (0..maxNrofCG-SL-1-r16)
SL-CG-MaxTransNumList-r16 ::= SEQUENCE (SIZE (1..8)) OF SL-CG-MaxTransNum-r16
SL-CG-MaxTransNum-r16 ::= SEQUENCE {
sl-Priority-r16 INTEGER (1..8),
sl-MaxTransNum-r16 INTEGER (1..32)
}
SL-PeriodCG-r16 ::= CHOICE{
sl-PeriodCG1-r16 ENUMERATED {ms100, ms200, ms300, ms400, ms500, ms600, ms700,
ms800, ms900, ms1000, spare6,
spare5, spare4, spare3, spare2, spare1},
sl-PeriodCG2-r16 INTEGER (1..99)
}
-- TAG-SL-CONFIGUREDGRANTCONFIG-STOP
-- ASN1STOP

SL- =ConfiguredGrantConfig field descriptions
SL-ConfigIndexCG
This field indicated the ID to identify configured grant for sidelink

SL-CG-MaxTransNumList
This field indicates the maximum number of times that a TB can be transmitted using the resources provided by the configured grant. sl-Priority corresponds to the logical channel priority.

SL-FreqResourceCG-Type1
Indicates the frequency resource location of sidelink configured grant type 1. An index giving valid combinations of one or two starting sub-channel and length (jointly encoded) as resource indicator (RIV), as defined in TS 38.214 [19].

SL-HARQ-ProcID-Offset
Indicates the offset used in deriving the HARQ process IDs for SL configured grant type 1 or SL configured type 2, see TS 38.321 [3], clause 5.8.3.

SL-N1PUCCH-AN
This field indicates the HARQ resource for PUCCH for sidelink configured grant type 1. The actual PUCCH-Resource is configured in sl-PUCCH-Config and referred to by its ID

SL-N1PUCCH-AN-Type2
This field indicates the HARQ resource for PUCCH for PSCCH/PSSCH transmissions without a corresponding PDCCH on sidelink configured grant type 2. The actual PUCCH-Resource is configured in sl-PUCCH-Config and referred to by its ID.

SL-NrOfHARQ-Processes
This field indicates the number of HARQ processes configured for a specific configured grant. It applies for both Type 1 and Type 2.

SL-PeriodCG
This field indicates the period of sidelink configured grant in the unit of ms.

SL-PSFCH-ToPUCCH-CG-Type1
This field, for configured grant type 1, indicates slot offset between the PSFCH associated with the last PSSCH resource of each period and the PUCCH occasion used for reporting sidelink HARQ

SL-ResourcePoolID
Indicates the resource pool in which the configured sidelink grant Type 1 is applied.

SL-StartSubchannelCG-Type1
This field indicates the starting sub-channel of sidelink configured grant Type 1. An index giving valid sub-channel index.

SL-TimeOffsetCG-Type1
This field indicates the slot offset with respect to logical slot defined by sl-TimeReferenceSFN-Type1, as specified in TS 38.321 [3].

SL-TimeReferenceSFN-Type1
Indicates SFN used for determination of the offset of a resource in time domain. If it is present, the UE uses the 1^{st} logical slot of associated resource pool after the starting time of the closest SFN with the indicated number preceding the reception of the sidelink configured grant configuration Type 1 as reference logical slot, see TS 38.321 [3], clause 5.8.3. If it is not present, the reference SFN is 0.

sl-TimeResourceCG-Type1
This field indicates the time resource location of sidelink configured grant Type 1. An index giving valid combinations of up to two slot positions (jointly encoded) as time resource indicator (TRIV), as defined in TS 38.212 [17].

SL-FreqConfig
The IE SL-FreqConfig specifies the dedicated configuration information on one particular carrier frequency for NR sidelink communication.

### SL-FREQCONFIG INFORMATION ELEMENT

-- ASN1START
-- TAG-SL-FREQCONFIG-START
SL-FreqConfig-r16 : := SEQUENCE {
sl-Freq-Id-r16 SL-Freq-Id-r16,
sl-SCS-SpecificCarrierList-r16 SEQUENCE (SIZE (1..maxSCSs)) OF SCS-SpecificCarrier,
sl-AbsoluteFrequencyPointA-r16 ARFCN-ValueNR
OPTIONAL, -- Need M
sl-AbsoluteFrequencySSB-r16 ARFCN-ValueNR
OPTIONAL, -- Need R
frequencyShift7p5khzSL-r16 ENUMERATED {true}
OPTIONAL, -- Cond V2X-SL-Shared
valueN-r16 INTEGER (-1. .1),
sl-BWP-ToReleaseList-r16 SEQUENCE (SIZE (1. .maxNrofSL-BWPs-r16) ) OF BWP-Id
OPTIONAL, -- Need N
sl-BWP-ToAddModList-r16 SEQUENCE (SIZE (1. .maxNrofSL-BWPs-r16) ) OF SL-BWP-Config-r16
OPTIONAL, -- Need N
sl-SyncConfigList-r16 SL-SyncConfigList-r16
OPTIONAL, -- Need M
sl-SyncPriority-r16 ENUMERATED {gnss, gnbEnb}
OPTIONAL -- Need M
}
SL-Freq-Id-r16 : := INTEGER (1. . maxNrofFreqSL-r16)
-- TAG-SL-FREQCONFIG-STOP
-- ASN1STOP

SL-FreqConfig Field Descriptions

FREQUENCYSHIFT7P5KHZSL
Enable the NR SL transmission with a 7.5 kHz shift to the LTE raster. If the field is absent, the frequency shift is disabled.

SL-AbsoluteFrequencyPointA
Absolute frequency of the reference resource block (Common RB 0). Its lowest subcarrier is also known as Point A.

SL-AbsoluteFrequencySSB
Indicates the frequency location of sidelink SSB. The transmission bandwidth for sidelink SSB is within the bandwidth of this sidelink BWP.

SL-BWP-ToAddModList
This field indicates the list of sidelink BWP(s) on which the NR sidelink communication configuration is to be added or reconfigured. In this release, only one BWP is allowed to be configured for NR sidelink communication.

SL-BWP-ToReleaseList
This field indicates the list of sidelink BWP(s) on which the NR sidelink communication configuration is to be released.

SL-Freq-Id
This field indicates the identity of the dedicated configuration information on the carrier frequency for NR sidelink communication.

SL-SCS-SpecificCarrierList
A set of UE specific channel bandwidth and location configurations for different subcarrier spacings (numerologies). Defined in relation to Point A. The UE uses the configuration provided in this field only for the purpose of channel bandwidth and location determination. In this release, only one SCS-SpecificCarrier is allowed to be configured for NR sidelink communication.

SL-SyncPriority
This field indicates synchronization priority order, as specified in clause 5.8.6.

ValueN
Indicate the NR SL transmission with a valueN *5 kHz shift to the LTE raster. (see TS 38.101-1 [15], clause 5.4E.2).

### SL-BWP-Config

The IE SL-BWP-Config is used to configure the UE specific NR sidelink communication on one particular sidelink bandwidth part.

### SL-BWP-CONFIG INFORMATION ELEMENT

-- ASN1START
-- TAG-SL-BWP-CONFIG-START
SL-BWP-Config-r16 : := SEQUENCE {
sl-BWP-Id BWP-Id,
sl-BWP-Generic-r16 SL-BWP-Generic-r16
OPTIONAL, -- Need M
sl-BWP-PoolConfig-r16 SL-BWP-PoolConfig-r16
OPTIONAL, -- Need M
...,
[[
sl-BWP-PoolConfigPS-r17 SetupRelease {SL-BWP-PoolConfigPS-r17}
OPTIONAL, -- Need M
sl-BWP-DiscPoolConfig-r17 SetupRelease {SL-BWP-DiscPoolConfig-r17}
OPTIONAL -- Need M
]]
}
SL-BWP-Generic-r16 : := SEQUENCE {
sl-BWP-r16 BWP
OPTIONAL, -- Need M
sl-LengthSymbols-r16 ENUMERATED {sym7, sym8, sym9, sym10, sym11, sym12,
sym13, sym14} OPTIONAL, -- Need M
sl-StartSymbol-r16 ENUMERATED {sym0, sym1, sym2, sym3, sym4, sym5, sym6,
sym7} OPTIONAL, -- Need M
sl-PSBCH-Config-r16 SetupRelease {SL-PSBCH-Config-r16}
OPTIONAL, -- Need M
sl-TxDirectCurrentLocation-r16 INTEGER (0..3301)
OPTIONAL, -- Need M
...
}
-- TAG-SL-BWP-CONFIG-STOP
-- ASN1STOP

SL-BWP-Config Field Descriptions

Sl-BWP-DiscPoolConfig
This field indicates the NR sidelink discovery dedicated resource pool configurations on the configured sidelink BWP. The total number of Rx/Tx resource pools configured for communication and discovery does not exceed the maximum number of Rx/Tx resource pool for NR sidelink communication (i.e. maxNrofRXPool-r16/maxNrofTXPool-r16).

SL-BWP-Generic
This field indicates the generic parameters on the configured sidelink BWP.

SL-BWP-PoolConfig
This field indicates the resource pool configurations on the configured sidelink BWP.

SL-BWP-Id
An identifier for this sidelink bandwidth part.

SL-BWP-PoolConfigPS
This field indicates the resource pool configurations for power saving on the configured sidelink BWP.

SL-BWP-Generic Field Descriptions

SL-LengthSymbols
This field indicates the number of symbols used for sidelink in a slot without SL-SSB. A single value can be (pre)configured per sidelink bandwidth part.

SL-StartSymbol
This field indicates the starting symbol used for sidelink in a slot without SL-SSB. A single value can be (pre)configured per sidelink bandwidth part.

SL-TxDirectCurrentLocation
The sidelink Tx/Rx Direct Current location for the carrier. Only values in the value range of this field between 0 and 3299, which indicate the subcarrier index within the carrier corresponding to the numerology of the corresponding sidelink BWP and value 3300, which indicates “Outside the carrier” and value 3301, which indicates “Undetermined position within the carrier” are used in this version of the specification.

SL-BWP-ConfigCommon
The IE SL-BWP-ConfigCommon is used to configure the cell-specific configuration information on one particular sidelink bandwidth part.

### SL-BWP-CONFIGCOMMON INFORMATION ELEMENT

-- ASN1START
-- TAG-SL-BWP-CONFIGCOMMON-START
SL-BWP-ConfigCommon-r16 : := SEQUENCE {
sl-BWP-Generic-r16 SL-BWP-Generic-r16
OPTIONAL, -- Need R
sl-BWP-PoolConfigCommon-r16 SL-BWP-PoolConfigCommon-r16
OPTIONAL, -- Need R
...,
[[
sl-BWP-PoolConfigCommonPS-r17 SL-BWP-PoolConfigCommonPS-r17
OPTIONAL, -- Need R
sl-BWP-DiscPoolConfigCommon-r17 SL-BWP-DiscPoolConfigCommon-r17
OPTIONAL -- Need R
]]
}
-- TAG-SL-BWP-CONFIGCOMMON-STOP
-- ASN1STOP

SL-BWP-ConfigCommon Field Descriptions

SL-BWP-DiscPoolConfigCommon
This field indicates the NR sidelink discovery dedicated resource pool configurations on the configured sidelink BWP. The total number of Rx/Tx resource pools configured for communication and discovery does not exceed the maximum number of Rx/Tx resource pool for NR sidelink communication (i.e. maxNrofRXPool-r16/maxNrofTXPool-r16).

SL-BWP-Generic
This field indicates the generic parameters on the configured sidelink BWP.

SL-BWP-PoolConfigCommon
This field indicates the resource pool configurations on the configured sidelink BWP.

SL-BWP-PoolConfigCommonPS
This field indicates the resource pool configurations for power saving on the configured sidelink BWP.

SL-FreqConfigCommon
The IE FreqConfigCommon specifies the cell-specific configuration information on one particular carrier frequency for NR sidelink communication.

### SL-FREQCONFIGCOMMON INFORMATION ELEMENT

-- ASN1START
-- TAG-SL-FREQCONFIGCOMMON-START
SL-FreqConfigCommon-r16 ::= SEQUENCE {
sl-SCS-SpecificCarrierList-r16 SEQUENCE (SIZE (1. .maxSCSs)) OF SCS-SpecificCarrier,
sl-AbsoluteFrequencyPointA-r16 ARFCN-ValueNR,
sl-AbsoluteFrequencySSB-r16 ARFCN-ValueNR
OPTIONAL, -- Need R
frequencyShift7p5khzSL-r16 ENUMERATED {true}
OPTIONAL, -- Cond V2X-SL-Shared
valueN-r16 INTEGER (-1. .1),
sl-BWP-List-r16 SEQUENCE (SIZE (1. .maxNrofSL-BWPs-r16) ) OF SL-BWP-ConfigCommon-
r16 OPTIONAL, -- Need R
sl-SyncPriority-r16 ENUMERATED {gnss, gnbEnb}
OPTIONAL, -- Need R
sl-NbAsSync-r16 BOOLEAN
OPTIONAL, -- Need R
sl-SyncConfigList-r16 SL-SyncConfigList-r16
OPTIONAL, -- Need R
...
}
-- TAG-SL-FREQCONFIGCOMMON-STOP
-- ASN1STOP

SL-FreqConfigCommon Field Descriptions

SL-BWP-List
This field indicates the list of sidelink BWP(s) on which the NR sidelink communication configuration. In this release, only one BWP is allowed to be configured for NR sidelink communication.

### - BWP-Uplink

The IE BWP-Uplink is used to configure an additional uplink bandwidth part (not for the initial BWP).

### BWP-UPLINK INFORMATION ELEMENT

-- ASN1START
-- TAG-BWP-UPLINK-START
BWP-Uplink ::= SEQUENCE {
bwp-Id BWP-Id,
bwp-Common BWP-UplinkCommon
OPTIONAL, -- Cond SetupOtherBWP
bwp-Dedicated BWP-UplinkDedicated
OPTIONAL, -- Cond SetupOtherBWP
...
}
-- TAG-BWP-UPLINK-STOP
-- ASN1STOP

### - BWP-UplinkDedicated

The IE BWP-UplinkDedicated is used to configure the dedicated (UE specific) parameters of an uplink BWP.

### BWP-UPLINKDEDICATED INFORMATION ELEMENT

-- ASN1START
-- TAG-BWP-UPLINKDEDICATED-START
BWP-UplinkDedicated ::= SEQUENCE {
pucch-Config SetupRelease { PUCCH-Config }
OPTIONAL, -- Need M
pusch-Config SetupRelease { PUSCH-Config }
OPTIONAL, -- Need M
configuredGrantConfig SetupRelease { ConfiguredGrantConfig }
OPTIONAL, -- Need M
srs-Config SetupRelease { SRS-Config }
OPTIONAL, -- Need M
beamFailureRecoveryConfig SetupRelease { BeamFailureRecoveryConfig }
OPTIONAL, -- Cond SpCellOnly
...,
[[
sl-PUCCH-Config-r16 SetupRelease { PUCCH-Config }
OPTIONAL, -- Need M
cp-ExtensionC2-r16 INTEGER (1. .28)
OPTIONAL, -- Need R
cp-ExtensionC3-r16 INTEGER (1. .28)
OPTIONAL, -- Need R
useInterlacePUCCH-PUSCH-r16 ENUMERATED {enabled}
OPTIONAL, -- Need R
pucch-ConfigurationList-r16 SetupRelease { PUCCH-ConfigurationList-r16 }
OPTIONAL, -- Need M
lbt-FailureRecoveryConfig-r16 SetupRelease { LBT-FailureRecoveryConfig-rl6 }
OPTIONAL, -- Need M
configuredGrantConfigToAddModList-r16 ConfiguredGrantConfigToAddModList-r16
OPTIONAL, -- Need N
configuredGrantConfigToReleaseList-r16 ConfiguredGrantConfigToReleaseList-r16
OPTIONAL, -- Need N
configuredGrantConfigType2DeactivationStateList-r16
ConfiguredGrantConfigType2DeactivationStateList-r16 OPTIONAL -- Need R
]],
[[
ul-TCIState CHOICE {
lists SEQUENCE {
ul-TCIState-ToAddModList-r17 SEQUENCE (SIZE (1. .maxULTCI-r17) ) OF UL-TCIState-r17
OPTIONAL, -- Need N
ul-TCIState-ToReleaseList-r17 SEQUENCE (SIZE (1. .maxULTCI-r17) ) OF UL-TCIState-Id-
r17 OPTIONAL -- Need N
},
refUnifiedTCIStateList-r17 RefUnifiedTCIStateList-r17
}
OPTIONAL, -- Need R
ul-powerControl-r17 Uplink-powerControlId-r17
OPTIONAL, -- Need R
pucch-ConfigurationListMulticast1-r17 SetupRelease { PUCCH-ConfigurationList-r16 }
OPTIONAL, -- Need M
pucch-ConfigurationListMulticast2-r17 SetupRelease { PUCCH-ConfigurationList-r16 }
OPTIONAL -- Need M
]]
}
ConfiguredGrantConfigToAddModList-r16 ::= SEQUENCE (SIZE (1. .maxNrofConfiguredGrantConfig-r16) ) OF
ConfiguredGrantConfig
ConfiguredGrantConfigToReleaseList-r16 ::= SEQUENCE (SIZE (1. .maxNrofConfiguredGrantConfig-r16) ) OF
ConfiguredGrantConfigIndex-r16
ConfiguredGrantConfigType2DeactivationState-r16 ::= SEQUENCE (SIZE (1..maxNrofConfiguredGrantConfig-
r16)) OF ConfiguredGrantConfigIndex-rl6
ConfiguredGrantConfigType2DeactivationStateList-r16 : :=
SEQUENCE (SIZE (1. .rnaxNrofCG-Type2DeactivationState)) OF
ConfiguredGrantConfigType2DeactivationState-r16
-- TAG-BWP-UPLINKDEDICATED-STOP
-- ASN1STOP

BWP-UplinkDedicated Field Descriptions
ConfiguredGrantConfig
A Configured-Grant of type 1 or type2. It may be configured for UL or SUL but in case of type 1 not for both at a time. Except for reconfiguration with sync, the NW does not reconfigure configuredGrantConfig when there is an active configured uplink grant Type 2 (see TS 38.321 [3]). However, the NW may release the configuredGrantConfig at any time. Network can only configure configured grant in one BWP using either this field or configuredGrantConfigToAddModList.

ConfiguredGrantConfigToAddModList
Indicates a list of one or more configured grant configurations to be added or modified for one BWP. Except for reconfiguration with sync, the NW does not reconfigure a Type 2 configured grant configuration when it is active (see TS 38.321 [3]). The network configures multiple CG configurations with either all configurations or no configuration configured with cg-RetransmissionTimer-r16.

ConfiguredGrantConfigToReleaseList
Indicates a list of one or more UL Configured Grant configurations to be released. The NW may release a configured grant configuration at any time.

ConfiguredGrantConfigType2DeactivationStateList
Indicates a list of the deactivation states in which each state can be mapped to a single or multiple Configured Grant type 2 configurations to be deactivated when the corresponding deactivation DCI is received, see clause 7.3.1 in TS 38.212 [17] and clause 10.2 in TS 38.213 [13].

PUCCH-Config
PUCCH configuration for one BWP of the normal UL or SUL of a serving cell. If the UE is configured with SUL, the network configures PUCCH only on the BWPs of one of the uplinks (normal UL or SUL). The network configures PUCCH-Config at least on non-initial BWP(s) for SpCell and PUCCH SCell. If supported by the UE, the network may configure at most one additional SCell of a cell group with PUCCH-Config (i.e. PUCCH SCell) ; if PUCCH cell switching is supported by the UE, the network may configure at most one additional SCell with PUCCH-Config within each PUCCH group.
In (NG)EN-DC and NE-DC, the NW configures at most one serving cell per frequency range with PUCCH. In (NG)EN-DC and NE-DC, if two PUCCH groups are configured, the serving cells of the NR PUCCH group in FR2 use the same numerology. For NR-DC, the maximum number of PUCCH groups in each cell group is one, and only the same numerology is supported for the cell group with carriers only in FR2.
The NW may configure PUCCH for a BWP when setting up the BWP. The network may also add/remove the pucch-Config in an RRCReconfiguration with reconfigurationWithSync (for SpCell or PUCCH SCell) or with SCell release and add (for PUCCH SCell) to move the PUCCH between the UL and SUL carrier of one serving cell. In other cases, only modifications of a previously configured pucch-Config are allowed.
If one (S)UL BWP of a serving cell is configured with PUCCH, all other (S)UL BWPs must be configured with PUCCH, too.

PUCCH-ConfigurationList
PUCCH configurations for two simultaneously constructed HARQ-ACK codebooks (see TS 38.213 [13], clause 9.1). Different PUCCH Resource IDs are configured in different PUCCH-Config within the pucch-ConfigurationList if configured.

PUCCH-ConfigurationListMulticast1
PUCCH configurations for two simultaneously constructed HARQ-ACK codebooks for MBS multicast (see TS 38.213, clause 9).

PUCCH-ConfigurationListMulticast2
PUCCH configurations for two simultaneously constructed NACK-only feedback for MBS multicast (see TS 38.213, clause 9).

PUSCH-Config
PUSCH configuration for one BWP of the normal UL or SUL of a serving cell. If the UE is configured with SUL and if it has a PUSCH-Config for both UL and SUL, an UL/SUL indicator field in DCI indicates which of the two to use. See TS 38.212 [17], clause 7.3.1.

SL-PUCCH-Config
Indicates the UE specific PUCCH configurations used for the HARQ-ACK feedback reporting for NR sidelink communication.

SRS-Config
Uplink sounding reference signal configuration.

UL-PowerControl
Configures power control parameters for PUCCH, PUSCH and SRS when UE is configured with unifiedtci-StateType. The field is present here only if UL power control is not configured for any UL TCI state and DLorJoint-TCIState.

UL-TCIState-ToAddModList
Indicates a lits of UL TCI states for PUCCH, PUSCH and SRS when UE is configured with unified TCI state operation as specified in TS 38.xxx

### - ServingCellConfig

The IE ServingCellConfig is used to configure (add or modify) the UE with a serving cell, which may be the SpCell or an SCell of an MCG or SCG. The parameters herein are mostly UE specific but partly also cell specific (e.g. in additionally configured bandwidth parts). Reconfiguration between a PUCCH and PUCCHless SCell is only supported using an SCell release and add.

### SERVINGCELLCONFIG INFORMATION ELEMENT

-- ASN1START
-- TAG-SERVINGCELLCONFIG-START
ServingCellConfig ::= SEQUENCE {
tdd-UL-DL-ConfigurationDedicated TDD-UL-DL-ConfigDedicated
OPTIONAL, -- Cond TDD
initialDownlinkBWP BWP-DownlinkDedicated
OPTIONAL, -- Need M
downlinkBWP-ToReleaseList SEQUENCE (SIZE (1. .maxNrofBWPs)) OF BWP-Id
OPTIONAL, -- Need N
downlinkBWP-ToAddModList SEQUENCE (SIZE (1. .maxNrofBWPs)) OF BWP-Downlink
OPTIONAL, -- Need N
firstActiveDownlinkBWP-Id BWP-Id
OPTIONAL, -- Cond SyncAndCellAdd
bwp-InactivityTimer ENUMERATED {ms2, ms3, ms4, ms5, ms6, ms8, ms10, ms20, ms30,
ms40,ms50, ms60, ms80,ms100, ms200,ms300, ms500,
ms750, ms1280, ms1920, ms2560, spare10, spare9,
spare8,
spare7, spare6, spare5, spared4, spare3, spare2,
spare1 } OPTIONAL, --Need R
defaultDownlinkBWP-Id BWP-Id
OPTIONAL, -- Need S
uplinkConfig UplinkConfig
OPTIONAL, -- Need M
supplementaryUplink UplinkConfig
OPTIONAL, -- Need M
pdcch-ServingCellConfig SetupRelease { PDCCH-ServingCellConfig }
OPTIONAL, -- Need M
pdsch-ServingCellConfig SetupRelease { PDSCH-ServingCellConfig }
OPTIONAL, -- Need M
csi-MeasConfig SetupRelease { CSI-MeasConfig }
OPTIONAL, -- Need M
sCellDeactivationTimer ENUMERATED {ms20, ms40, ms80, ms160, ms200, ms240,
...ms320, ms400, ms480, ms520, ms640, ms720,
UplinkConfig ::= SEQUENCE {
initialUplinkBWP BWP-UplinkDedicated
OPTIONAL, -- Need M
uplinkBWP-ToReleaseList SEQUENCE (SIZE (1. .maxNrofBWPs)) OF BWP-Id
OPTIONAL, -- Need N
uplinkBWP-ToAddModList SEQUENCE (SIZE (1. .maxNrofBWPs)) OF BWP-Uplink
OPTIONAL, -- Need N
firstActiveUplinkBWP-Id BWP-Id
OPTIONAL, -- Cond SyncAndCellAdd
pusch-ServingCellConfig SetupRelease { PUSCH-ServingCellConfig }
OPTIONAL, -- Need M
...
}
...

ChannelAccessConfig Field Descriptions
DownlinkBWP-ToAddModList
List of additional downlink bandwidth parts to be added or modified. (see TS 38.213 [13], clause 12).

DownlinkBWP-ToReleaseList
List of additional downlink bandwidth parts to be released. (see TS 38.213 [13], clause 12).

DownlinkChanneIBW-PerSCS-List
A set of UE specific channel bandwidth and location configurations for different subcarrier spacings (numerologies). Defined in relation to Point A. The UE uses the configuration provided in this field only for the purpose of channel bandwidth and location determination. If absent, UE uses the configuration indicated in scs-SpecificCarrierList in DownlinkConfigCommon / DownlinkConfigCommonSIB. Network only configures channel bandwidth that corresponds to the channel bandwidth values defined in TS 38.101-1 [15] and TS 38.101-2 [39].

FirstActiveDownlinkBWP-Id
If configured for an SpCell, this field contains the ID of the DL BWP to be activated or to be used for RLM, BFD and measurements if included in an RRCReconfiguration message contained in an NR or E-UTRA RRC message indicating that the SCG is deactivated, upon performing the RRC (re-)configuration. If the field is absent, the RRC (re-)configuration does not impose a BWP switch. If the field is absent for the PSCell at SCG deactivation, the UE considers the previously activated DL BWP as the BWP to be used for RLM, BFD and measurements. If the field is absent for the PSCell at SCG activation, the DL BWP to be activated is the DL BWP previously to be used for RLM, BFD and measurements.
If configured for an SCell, this field contains the ID of the downlink bandwidth part to be used upon activation of an SCell. The initial bandwidth part is referred to by BWP-Id = 0.
Upon reconfiguration with reconfigurationWithSync, the network sets the firstActiveDownlinkBWP-Idand firstActiveUplinkBWP-Id to the same value.

InitialDownlinkBWP
The dedicated (UE-specific) configuration for the initial downlink bandwidth-part (i.e. DL BWP#0). If any of the optional IEs are configured within this IE, the UE considers the BWP#0 to be an RRC configured BWP (from UE capability viewpoint). Otherwise, the UE does not consider the BWP#0 as an RRC configured BWP (from UE capability viewpoint). Network always configures the UE with a value for this field if no other BWPs are configured. NOTE1

Tag-Id
Timing Advance Group ID, as specified in TS 38.321 [3], which this cell belongs to.

UplinkConfig Field Descriptions
FirstactiveuplinkBWP-Id
If configured for an SpCell, this field contains the ID of the UL BWP to be activated upon performing the RRC (reconfiguration. If the field is absent, the RRC (re-)configuration does not impose a BWP switch.
If configured for an SCell, this field contains the ID of the uplink bandwidth part to be used upon activation of an SCell. The initial bandwidth part is referred to by BandiwdthPartld = 0.

InitialUplinkBWP
The dedicated (UE-specific) configuration for the initial uplink bandwidth-part (i.e. UL BWP#0). If any of the optional lEs are configured within this IE as part of the IE uplinkConfig, the UE considers the BWP#0 to be an RRC configured BWP (from UE capability viewpoint). Otherwise, the UE does not consider the BWP#0 as an RRC configured BWP (from UE capability viewpoint). Network always configures the UE with a value for this field if no other BWPs are configured. NOTE1

### ConfiguredGrantConfig

The IE ConfiguredGrantConfig is used to configure uplink transmission without dynamic grant according to two possible schemes. The actual uplink grant may either be configured via RRC (type1) or provided via the PDCCH (addressed to CS-RNTI) (type2). Multiple Configured Grant configurations may be configured in one BWP of a serving cell.

### CONFIGUREDGRANTCONFIG INFORMATION ELEMENT

-- ASN1START
-- TAG-CONFIGUREDGRANTCONFIG-START
ConfiguredGrantConfig ::= SEQUENCE {
frequencyHopping ENUMERATED {intraSlot, interSlot}
OPTIONAL, -- Need S
cg-DMRS-Configuration DMRS-UplinkConfig,
mcs-Table ENUMERATED {qam256, qam64LowSE}
OPTIONAL, -- Need S
mcs-TableTransformPrecoder ENUMERATED {qam256, qam64LowSE}
OPTIONAL, -- Need S
uci-OnPUSCH SetupRelease { CG-UCI-OnPUSCH }
OPTIONAL, -- Need M
resourceAllocation ENUMERATED { resourceAllocationTypeO,
resourceAllocationType1, dynamicSwitch },
rbg-Size ENUMERATED {config2}
OPTIONAL, -- Need S
powerControlLoopToUse ENUMERATED {n0, n1},
p0-PUSCH-Alpha P0-PUSCH-AlphaSetId,
transformPrecoder ENUMERATED (enabled, disabled}
OPTIONAL, -- Need S
nrofHARQ-Processes INTEGER(1..16),
repK ENUMERATED {n1, n2, n4, n8},
repK-RV ENUMERATED {sl-0231, s2-0303, s3-0000}
OPTIONAL, -- Need R
periodicity ENUMERATED {
sym2, sym7, sym1x14, sym2x14, sym4x14, sym5x14,
sym8x14, sym10x14, sym16x14, sym20x14,
sym32x14, sym40x14, sym64x14, sym80x14, sym128x14,
sym160x14, sym256x14, sym320x14, sym512x14,
sym640x14, sym1024x14, sym1280x14, sym2560x14,
sym5120x14,
sym6, sym1x12, sym2x12, syrn4x12, sym5x12, sym8x12,
syrn10x12, sym16x12, sym20x12, sym32x12,
sym40x12, sym64x12, sym80x12, sym128x12, sym160x12,
sym256x12, sym320x12, sym512x12, sym640x12,
sym1280x12, sym2560x12
},
configuredGrantTimer INTEGER (1..64)
OPTIONAL, -- Need R
rrc-ConfiguredUplinkGrant SEQUENCE {
timeDomainOffset INTEGER (0..5119),
timeDomainAllocation INTEGER (0..15),
frequencyDomainAllocation BIT STRING (SIZE(18)),
antennaPort INTEGER (0..31),
dmrs-SeqInitialization INTEGER (0..1)
OPTIONAL, -- Need R
precodingAndNumberOfLayers INTEGER (0..63),
srs-ResourceIndicator INTEGER (0..15)
OPTIONAL, -- Need R
mcsAndTBS INTEGER (0..31),
frequencyHoppingOffset INTEGER (1.. maxNrofPhysicalResourceBlocks-1)
OPTIONAL, -- Need R
pathlossReferenceIndex INTEGER (0..maxNrofPUSCH-PathlossReferenceRSs-1),
...,
[[
pusch-RepTypeIndicator-r16 ENUMERATED {pusch-RepTypeA,pusch-RepTypeB}
OPTIONAL, -- Need M
frequencyHoppingPUSCH-RepTypeB-r16 ENUMERATED {interRepetition, interSlot}
OPTIONAL, -- Cond RepTypeB
timeReferenceSFN-r16 ENUMERATED {sfn512)
OPTIONAL -- Need S
]],
[[
pathlossReferenceIndex2-r17 INTEGER (0..maxNrofPUSCH-PathlossReferenceRSs-1)
OPTIONAL, -- Need R
srs-ResourceIndicator2-r17 INTEGER (0..15)
OPTIONAL, -- Need R
precodingAndNumberOfLayers2-rl7 INTEGER (0..63)
OPTIONAL, -- Need R
timeDomainOffset-rl7 INTEGER (0..40959)
OPTIONAL, -- Need R
cg-SDT-Configuration-rl7 CG-SDT-Configuration-r17
OPTIONAL -- Need M
]]
}
OPTIONAL, -- Need R
...,
[[
cg-RetransmissionTimer-r16 INTEGER (1..64)
OPTIONAL, -- Need R
cg-minDFI-Delay-r16 ENUMERATED
{sym7, sym1x14, sym2x14, sym3x14, syrn4x14,
sym5x14, syrn6x14, sym7x14, syrn8x14,
sym9x14, sym10x14, sym11x14, syrn12x14, sym13x14,
sym14x14,sym15x14, sym16x14
}
OPTIONAL, -- Need R
cg-nrofPUSCH-InSlot-rl6 INTEGER (1..7)
OPTIONAL, -- Need R
cg-nrofSlots-r16 INTEGER (1..40)
OPTIONAL, -- Need R
cg-StartingOffsets-r16 CG-StartingOffsets-r16
OPTIONAL, -- Need R
cg-UCI-Multiplexing-rl6 ENUMERATED {enabled}
OPTIONAL, -- Need R
cg-COT-SharingOffset-r16 INTEGER (1..39)
OPTIONAL, -- Need R
betaOffsetCG-UCI-r16 INTEGER (0..31)
OPTIONAL, -- Need R
cg-COT-SharingList-r16 SEQUENCE (SIZE (1..1709)) OF CG-COT-Sharing-r16
OPTIONAL, -- Need R
harq-ProcID-Offset-r16 INTEGER (0..15)
OPTIONAL, -- Need M
harq-ProcID-Offset2-rl6 INTEGER (0..15)
OPTIONAL, -- Need M
configuredGrantConfigIndex-rl6 ConfiguredGrantConfigIndex-r16
OPTIONAL, -- Cond CG-List
configuredGrantConfigIndexMAC-r16 ConfiguredGrantConfigIndexMAC-r16
OPTIONAL, -- Cond CG-IndexMAC
periodicityExt-r16 INTEGER (1..5120)
OPTIONAL, -- Need R
startingFromRV0-r16 ENUMERATED {on, off}
OPTIONAL, -- Need R
phy-PriorityIndex-r16 ENUMERATED {p0, pl}
OPTIONAL, -- Need R
autonomousTx-r16 ENUMERATED {enabled}
OPTIONAL -- Cond LCH-BasedPrioritization
]],
[[
cg-betaOffsetsCrossPriO-r17 SetupRelease { BetaOffsetsCrossPriSelCG-r17 }
OPTIONAL, -- Need M
cg-betaOffsetsCrossPri1-r17 SetupRelease { BetaOffsetsCrossPriSelCG-r17 }
OPTIONAL, -- Need M
mappingPattern-r17 ENUMERATED {cyclicMapping, sequentialMapping}
OPTIONAL, -- Need R
sequenceOffsetForRV-r17 INTEGER (0..3)
OPTIONAL, -- Need R
p0-PUSCH-Alpha2-r17 PO-PUSCH-AlphaSetId
OPTIONAL, -- Need R
powerControlLoopToUse2-r17 ENUMERATED {n0, n1}
OPTIONAL, -- Need R
cg-COT-SharingList-r17 SEQUENCE (SIZE (1..1709)) OF CG-COT-Sharing-r17
OPTIONAL, -- Need R
periodicityExt-r17 INTEGER (1..40960)
OPTIONAL, -- Need R
repK-r17 ENUMERATED {n12, n16, n24, n32}
OPTIONAL, -- Need M
nrofHARQ-ProcessesExt-r17 INTEGER(17..32)
OPTIONAL, -- Need M
harq-ProcID-Offset-v17 INTEGER (16..31)
OPTIONAL, -- Need M
harq-ProcID-Offset2-v1700 INTEGER (16..31)
OPTIONAL, -- Need M
configuredGrantTimer-v1700 INTEGER(66..576)
OPTIONAL -- Need R
]]
}
CG-UCI-OnPUSCH ::= CHOICE {
dynamic SEQUENCE (SIZE (1..4)) OF BetaOffsets,
semiStatic BetaOffsets
}
CG-COT-Sharing-r16 ::= CHOICE {
noCOT-Sharing-r16 NULL,
cot-Sharing-r16 SEQUENCE {
duration-r16 INTEGER (1..39),
offset-r16 INTEGER (1..39),
channelAccessPriority-r16 INTEGER (1..4)
}
}
CG-COT-Sharing-r17 ::= CHOICE {
noCOT-Sharing-r17 NULL,
cot-Sharing-r17 SEQUENCE {
duration-r17 INTEGER (1..139),
offset-r17 INTEGER (1..139)
}
}
CG-StartingOffsets-r16 ::= SEQUENCE {
cg-StartingFullBW-InsideCOT-r16 SEQUENCE (SIZE (1..7)) OF INTEGER (0..6)
OPTIONAL, -- Need R
cg-StartingFullBW-OutsideCOT-rl6 SEQUENCE (SIZE (1..7)) OF INTEGER (0..6)
OPTIONAL, -- Need R
cg-StartingPartialBW-InsideCOT-r16 INTEGER (0..6)
OPTIONAL, -- Need R
cg-StartingPartialBW-OutsideCOT-r16 INTEGER (0..6)
OPTIONAL -- Need R
}
BetaOffsetsCrossPriSelCG-r17 ::= CHOICE {
dynamic-rl7 SEQUENCE (SIZE (1..4)) OF BetaOffsetsCrossPri-r17,
semiStatic-rl7 BetaOffsetsCrossPri-r17
}
CG-SDT-Configuration-r17 ::= SEQUENCE {
cg-SDT-RetransmissionTimer INTEGER (1..64)
OPTIONAL, -- Need R
sdt-SSB-Subset-r17 CHOICE {
shortBitmap-r17 BIT STRING (SIZE (4)),
mediumBitmap-r17 BIT STRING (SIZE (8)),
longBitmap-r17 BIT STRING (SIZE (64))
}
OPTIONAL, -- Need S
sdt-SSB-PerCG-PUSCH-r17 ENUMERATED {oneEighth, oneFourth, half, one, two, four, eight, sixteen)
OPTIONAL, -- Need M
sdt-PO-PUSCH-r17 INTEGER (-16..15)
OPTIONAL, -- Need M
sdt-Alpha-r17 ENUMERATED {alpha0, alpha04, alpha05, alpha06, alpha07, alpha08,
alpha09, alpha1} OPTIONAL, -- Need M
sdt-DMRS-Ports-r17 CHOICE {
dmrsTypel-r17 BIT STRING (SIZE (8)),
dmrsType2-r17 BIT STRING (SIZE (12))
}
OPTIONAL, -- Need M
sdt-NrofDMRS-Sequences-r17 INTEGER (1..2)
OPTIONAL -- Need M
}
-- TAG-CONFIGUREDGRANTCONFIG-STOP
-- ASNISTOP

ConfiguredGrantConfig Field Descriptions
AutonomousTx
If this field is present, the Configured Grant configuration is configured with autonomous transmission, see TS 38.321 [3].

Cg-nrofPUSCH-InSlot
Indicates the number of consecutive PUSCH configured to CG within a slot where the SLIV indicating the first PUSCH and additional PUSCH appended with the same length (see TS 38.214 [19], clause 6.1.2.3).

Cg-nrofSlots
Indicates the number of allocated slots in a configured grant periodicity following the time instance of configured grant offset (see TS 38.214 [19], clause 6.1.2.3).

Cg-RetransmissionTimer
Indicates the initial value of the configured retransmission timer (see TS 38.321 [3]) in multiples of periodicity. The value of cg-RetransmissionTimer is always less than or equal to the value of configuredGrantTimer. This field is always configured together with harq-ProcID-Offset. This field is not configured for operation in licensed spectrum or simultaneously with harq-ProcID-Offset2.

Cg-StartingOffsets
This field is not applicable for a UE which is allowed to operate as an initiating device in semi-static channel access mode, i.e., not applicable for a UE configured with UE FFP parameters (e.g. period, offset) regardless whether the UE would initiate its own COT or would share gNB’s COT.

Cg-UCI-Multiplexing
If present, this field indicates that in the case of PUCCH overlapping with CG-PUSCH(s) within a PUCCH group, the CG-UCI and HARQ-ACK are jointly encoded (see TS 38.213 [13], clause 9).

ConfiguredGrantConfigindex
Indicates the index of the Configured Grant configurations within the BWP.

ConfiguredGrantConfigIndexMAC
Indicates the index of the Configured Grant configurations within the MAC entity.

ConfiguredGrantTimer
Indicates the initial value of the configured grant timer (see TS 38.321 [3]) in multiples of periodicity. When cg-RetransmissonTimer is configured, if HARQ processes are shared among different configured grants on the same BWP, configuredGrantTimer * periodicity is set to the same value for the configurations that share HARQ processes on this BWP.

FrequencyDomainAllocation
Indicates the frequency domain resource allocation, see TS 38.214 [19], clause 6.1.2, and TS 38.212 [17], clause 7.3.1).

FrequencyHopping
The value intraSlot enables ‘Intra-slot frequency hopping’ and the value interSlot enables ‘Inter-slot frequency hopping’. If the field is absent, frequency hopping is not configured. The field frequencyHopping applies to configured grant for ‘pusch-RepTypeA’ (see TS 38.214 [19], clause 6.3.1).

FrequencyHoppingOffset
Frequency hopping offset used when frequency hopping is enabled (see TS 38.214 [19], clause 6.1.2 and clause 6.3).

FrequencyHoppingPUSCH-RepTypeB
Indicates the frequency hopping scheme for Type 1 CG when pusch-RepTypeIndicator is set to ‘pusch-RepTypeB’ (see TS 38.214 [19], clause 6.1). The value interRepetition enables ‘Inter-repetition frequency hopping’, and the value interSlot enables ‘Inter-slot frequency hopping’. If the field is absent, the frequency hopping is not enabled for Type 1 CG.

Harq-ProcID-Offset
For operation with shared spectrum channel access configured with cg-RetransmissionTimer-r16, this configures the range of HARQ process IDs which can be used for this configured grant where the UE can select a HARQ process ID within [harq-proc/D-offset, .., (harq-proc/D-offset + nrofHARQ-Processes - 1)].

Harq-ProcID-Offset2
Indicates the offset used in deriving the HARQ process IDs, see TS 38.321 [3], clause 5.4.1. This field is not configured together with cg-RetransmissionTimer-r16.

MappingPattern
Indicates whether the UE should follow Cyclical mapping pattern or Sequential mapping pattern when two SRS resource sets are configured for PUSCH transmission with a Type 1 configured grant and/or a Type 2 configured grant as described in clause 6.1.2.3 of TS 38.214 [19]

MCS-Table
Indicates the MCS table the UE shall use for PUSCH without transform precoding. If the field is absent the UE applies the value qam64.

MCS-TableTransformPrecoder
Indicates the MCS table the UE shall use for PUSCH with transform precoding. If the field is absent the UE applies the value qam64.

McsAndTBS
The modulation order, target code rate and TB size (see TS 38.214 [19], clause 6.1.2). The NW does not configure the values 28~31 in this version of the specification.

NrofHARQ-Processes, nrofHARQ-ProcessesExt
The number of HARQ processes configured. It applies for both Type 1 and Type 2. See TS 38.321 [3], clause 5.4.1. If the UE is configured with nrofHARQ-ProcessesExt, the UE shall ignore nrofHARQ-Processes.

PathlossReferenceIndex2
Indicates the reference signal used as PUSCH pathloss reference for the second SRS resource set. When this field is present, pathlossReferencelndex indicates the reference signal used as PUSCH pathloss reference for the first SRS resource set

p0-PUSCH-Alpha
Index of the P0-PUSCH-AlphaSet to be used for this configuration.

p0-PUSCH-Alpha2
Index of the P0-PUSCH-AlphaSet to be used for second SRS resource set. If this field is present, the p0-PUSCH-Alpha provides index for the P0-PUSCH-AlphaSet to be used for first SRS resource set.

Periodicity
Periodicity for UL transmission without UL grant for type 1 and type 2 (see TS 38.321 [3], clause 5.8.2).
The following periodicities are supported depending on the configured subcarrier spacing [symbols]:
15 kHz: 2, 7, n*14, where n={1, 2, 4, 5, 8, 10, 16, 20, 32, 40, 64, 80, 128, 160, 320, 640}
30 kHz: 2, 7, n*14, where n={1, 2, 4, 5, 8, 10, 16, 20, 32, 40, 64, 80, 128, 160, 256, 320, 640, 1280}
60 kHz with normal CP 2, 7, n*14, where n={1, 2, 4, 5, 8, 10, 16, 20, 32, 40, 64, 80, 128, 160, 256, 320, 512, 640, 1280, 2560}
60 kHz with ECP: 2, 6, n*12, where n={1, 2, 4, 5, 8, 10, 16, 20, 32, 40, 64, 80, 128, 160, 256, 320, 512, 640, 1280, 2560}
120 kHz: 2, 7, n*14, where n={1, 2, 4, 5, 8, 10, 16, 20, 32, 40, 64, 80, 128, 160, 256, 320, 512, 640, 1024, 1280, 2560, 5120}
480 and 960 kHz: n*14, where n={1, 2, 4, 5, 8, 10, 16, 20, 32, 40, 64, 80, 128, 160, 256, 320, 512, 640, 1024, 1280, 2560, 5120}

PeriodicityExt
This field is used to calculate the periodicity for UL transmission without UL grant for type 1 and type 2 (see TS 38.321 [3], clause 5,8.2). If this field is present, the field periodicity is ignored.
The following periodicites are supported depending on the configured subcarrier spacing [symbols]:
15 kHz: periodicityExt′14, where periodicityExt has a value between 1 and 640.
30 kHz: periodicityExt′14, where periodicityExt has a value between 1 and 1280.
60 kHz with normal CP: periodicityExt′14, where periodicityExt has a value between 1 and 2560.
60 kHz with ECP: periodicityExt*12, where periodicityExt has a value between 1 and 2560.
120 kHz: periodicityExt′14, where periodicityExt has a value between 1 and 5120.
480 kHz: periodicityExt*14, where periodicityExt has a value between 1 and 20480.
960 kHz: periodicityExt*14, where periodicityExt has a value between 1 and 40960.

Phy-PriorityIndex
Indicates the PHY priority of CG PUSCH at least for PHY-layer collision handling. Value p0 indicates low priority and value p1 indicates high priority. The network does not configure this for CG-SDT.

PowerControlLoopToUse
Closed control loop to apply (see TS 38.213 [13], clause 7.1.1).

PowerControlLoopToUse2
Closed control loop to apply to second SRS resource set (see TS 38.213 [13], clause 7.1.1). If this field is present, the powerControlLoopToUse applies to the first SRS resource set.

PrecodingAndNumberOfLayers
Precoding and number of MIMO layers applicable (see TS 38.213 [13], clause 7.1.1). In case of CG-SDT network configures single antenna port for single layer transmission.

PrecodingAndNumberOfLayers2
Indicates the precoding and number of layers for the second SRS resource set. When this field is present, precodingAndNumberOfLayers indicated the precoding and number of layers for the first SRS resource set.

Pusch-RepTypeIndicator
Indicates whether UE follows the behavior for PUSCH repetition type A or the behavior for PUSCH repetition type B for each Type 1 configured grant configuration. The value pusch-RepTypeA enables the ‘PUSCH repetition type A’ and the value pusch-RepTypeB enables the ‘PUSCH repetition type B’ (see TS 38.214 [19], clause 6.1.2.3). The value pusch-RepTypeB is not configured simultaneously with cg-nrofPUSCH-InSlot-r16 and cg-nrofSlots-r16. The network does not configure this field if cg-RetransmissionTimer-r16 is configured for CG operation with shared spectrum channel access.

RBG-Size
Selection between configuration 1 and configuration 2 for RBG size for PUSCH. The UE does not apply this field if resourceAllocation is set to resourceAllocationType1. Otherwise, the UE applies the value config1 when the field is absent. Note: rbg-Size is used when the transformPrecoder parameter is disabled.

RepK-RV
The redundancy version (RV) sequence to use. See TS 38.214 [19], clause 6.1.2. The network configures this field if repetitions are used, i.e., if repK is set to n2, n4 or n8. This field is not configured when cg-RetransmissionTimer is configured. Otherwise, the field is absent.

RepK
Number of repetitions K, see TS 38.214 [19]. If the field repK-r17 is present, the UE shall ignore the repK (without suffix).

ResourceAllocation
Configuration of resource allocation type 0 and resource allocation type 1. For Type 1 UL data transmission without grant, resourceAllocation should be resourceAllocationType0 or resourceAllocationType1.

RRC-ConfiguredUplinkGrant
Configuration for “configured grant” transmission with fully RRC-configured UL grant (Type1). If this field is absent the UE uses UL grant configured by DCI addressed to CS-RNTI (Type2).

SequenceOffsetForRV
Configures the RV offset for the starting RV for the first repetition (first actual repetition in PUSCH repetition Type B) towards the second ‘SRS resource set’ for PUSCH.

SRS-ResourceIndicator
Indicates the SRS resource to be used. The network does not configure this for CG-SDT.

SRS-ResourceIndicator2
Indicates the SRS resource to be used for the second SRS resource set. When this field is present, the srs-ResourceIndicator is used for the first SRS resource set.

StartingFromRV0
This field is used to determine the initial transmission occasion of a transport block for a given RV sequence, see TS 38.214 [19], clause 6.1.2.3.1. The network does not configure this field if cg-RetransmissionTimer-r16 is configured for CG operation.

TimeDomainAllocation
Indicates a combination of start symbol and length and PUSCH mapping type, see TS 38.214 [19], clause 6.1.2 and TS 38.212 [17], clause 7.3.1.

TimeDomainOffset
Offset related to the reference SFN indicated by timeReferenceSFN, see TS 38.321 [3], clause 5.8.2. timeDomainOffset-r17 is only applicable to 480 kHz and 960 kHz. If timeDomainOffset-r17 is present, the UE shall ignore timeDomainOffset (without suffix).

TimeReferenceSFN
Indicates SFN used for determination of the offset of a resource in time domain. The UE uses the closest SFN with the indicated number preceding the reception of the configured grant configuration, see TS 38.321 [3], clause 5.8.2. If the field timeReferenceSFN is not present, the reference SFN is 0.

TransformPrecoder
Enables or disables transform precoding for type1 and type2. If the field is absent, the UE enables or disables transform precoding in accordance with the field msg3-transformPrecoder in RACH-ConfigCommon, see TS 38.214 [19], clause 6.1.3.

UCI-OnPUSCH
Selection between and configuration of dynamic and semi-static beta-offset. For Type 1 UL data transmission without grant, uci-OnPUSCH should be set to semiStatic.

In the 3GPP specification 38.300 (e.g., [3] 3GPP 38.300 v17.0.0), PC5 interface and Uu interface are introduced:

### 16.9 Sidelink

### 16.9.1 General

In this clause, an overview of NR sidelink communication and how NG-RAN supports NR sidelink communication and V2X sidelink communication is given. V2X sidelink communication is specified in TS 36.300 [2].

The NG-RAN architecture supports the PC5 interface as illustrated in FIG. 16.9.1-1. Sidelink transmission and reception over the PC5 interface are supported when the UE is inside NG-RAN coverage, irrespective of which RRC state the UE is in, and when the UE is outside NG-RAN coverage.

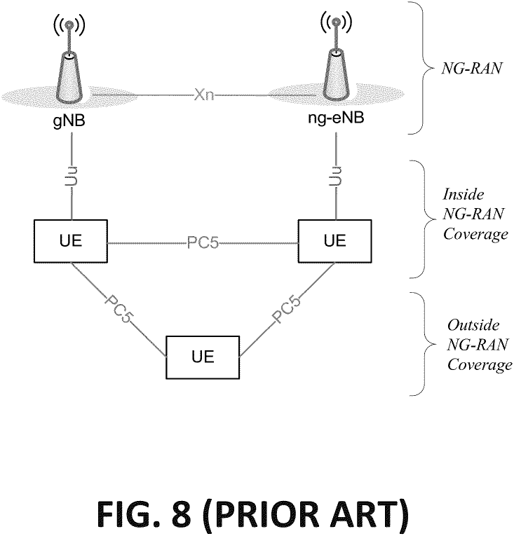

FIG. 8 is a reproduction of FIG. 16.9.1-1: NG-RAN Architecture supporting the PC5 interface, from 3GPP 38.300 v17.0.0.

Support of V2X services via the PC5 interface can be provided by NR sidelink communication and/or V2X sidelink communication. NR sidelink communication may be used to support other services than V2X services.

NR sidelink communication can support one of three types of transmission modes for a pair of a Source Layer-2 ID and a Destination Layer-2 ID in the AS:
Unicast transmission, characterized by:
   Support of one PC5-RRC connection between peer UEs for the pair;
   Transmission and reception of control information and user traffic between peer UEs in sidelink;
   Support of sidelink HARQ feedback;
   Support of sidelink transmit power control;
   Support of RLC AM;
   Detection of radio link failure for the PC5-RRC connection.
Groupcast transmission, characterized by:
   Transmission and reception of user traffic among UEs belonging to a group in sidelink;
   Support of sidelink HARQ feedback.
Broadcast transmission, characterized by:
   Transmission and reception of user traffic among UEs in sidelink.

In 3GPP 36.331 (e.g., [4] 3GPP 36.331 v16.0.0), Semi-persistent scheduling configuration (SPS-config) (for a serving cell) is introduced:

### SPS-Config

The IE SPS-Config is used to specify the semi-persistent scheduling configuration.

### SPS-CONFIG INFORMATION ELEMENT

-- ASN1START
SPS-Config ::= SEQUENCE {
semiPersistSchedC-RNTT C-RNTI OPTIONAL, -- Need OR
sps-ConfigDL SPS-ConfigDL OPTIONAL, -- Need ON
sps-ConfigUL SPS-ConfigUL OPTIONAL -- Need ON
}
SPS-Config-v1430 ::= SEQUENCE {
ul-SPS-V-RNTI-r14 C-RNTI OPTIONAL, -- Need OR
sl-SPS-V-RNTI-r14 C-RNTI OPTIONAL, -- Need OR
sps-ConfigUL-ToAddModList-r14 SPS-ConfigUL-ToAddModList-rl4 OPTIONAL, -- Need ON
sps-ConfigUL-ToReleaseList-r14 SPS-ConfigUL-ToReleaseList-r14 OPTIONAL, -- Need ON
sps-ConfigSL-ToAddModList-r14 SPS-ConfigSL-ToAddModList-r14 OPTIONAL, -- Need ON
sps-ConfigSL-ToReleaseList-r14 SPS-ConfigSL-ToReleaseList-r14 OPTIONAL -- Need ON
}
SPS-ConfigUL-ToAddModList-r14 ::= SEQUENCE (SIZE (1..maxConfigSPS-r14)) OF SPS-ConfigUL
SPS-ConfigUL-ToReleaseList-r14 ::= SEQUENCE (SIZE (1..maxConfigSPS-r14)) OF SPS-ConfigIndex-r14
SPS-ConfigSL-ToAddModList-r14 ::= SEQUENCE (SIZE (1..maxConfigSPS-r14)) OF SPS-ConfigSL-r14
SPS-ConfigSL-ToReleaseList-r14 ::= SEQUENCE (SIZE (1..maxConfigSPS-r14)) OF SPS-ConfigIndex-r14
SPS-Config-v1530 ::= SEQUENCE {
semiPersistSchedC-RNTI-r15 C-RNTI OPTIONAL, -- Need OR
sps-ConfigDL-r15 SPS-ConfigDL OPTIONAL, -- Need ON
sps-ConfigUL-STTI-ToAddModList-r15 SPS-ConfigUL-STTI-ToAddModList-r15 OPTIONAL, -- Need ON
sps-ConfigUL-STTI-ToReleaseList-r15 SPS-ConfigUL-STTI-ToReleaseList-r15 OPTIONAL, -- Need ON
sps-ConfigUL-ToAddModList-r15 SPS-ConfigUL-ToAddModList-r15 OPTIONAL, -- Need ON
sps-ConfigUL-ToReleaseList-r15 SPS-ConfigUL-ToReleaseList-r15 OPTIONAL -- Need ON
}
SPS-ConfigSL-r14 ::= SEQUENCE {
sps-ConfigIndex-r14 SPS-ConfigIndex-r14,
semiPersistSchedIntervalSL-rl4 ENUMERATED {
sf20, sf50, sf100, sf200, sf300, sf400,
sf500, sf600, sf700, sf800, sf900, sf1000,
spared, spare3, spare2, spare1}
}
SPS-ConfigIndex-r14 ::= INTEGER (1..maxConfigSPS-r14)
SPS-ConfigIndex-r15 ::= INTEGER (1..maxConfigSPS-r15)
...
-- ASN1STOP

1>SPS-Config field descriptions
semiPersistSchedintervalSL
Semi-persistent scheduling interval in sidelink, see TS 36.321 [6]. Value in number of sub-frames. Value sf20 corresponds to 20 sub-frames, sf50 corresponds to 50 sub-frames and so on.

sl-SPS-V-RNTI
SL Semi-Persistent Scheduling V-RNTI for V2X sidelink communication, see TS 36.321 [6].

sps-ConfigIndex
Indicates the index of one of multiple SL/UL SPS configurations.

sps-ConfigDL-STTI
If sps-ConfigDL-sTTI-r15 is signalled, the UE ignores sps-ConfigDL.

sps-ConfigSL-ToAddModList
Indicates the SL SPS configurations to be added or modified, identified by SPS-ConfigIndex.

sps-ConfigSL-ToReleaseList
Indicates the SL SPS configurations to be released, identified by SPS-Configlndex.

In Work item description for NR sidelink evolution (e.g., [5] RP-220300 WID revision: NR sidelink evolution), SL Carrier aggregation is discussed:

### 4.1 Objective of SI or Core Part WI or Testing Part WI

To check in RAN#97 for objectives 1 and 3, taking into account the progress on objectives 2 and 4, aiming to have specification work for both objective 1 and 3.

1. Specify mechanism to support NR sidelink CA operation based on LTE sidelink CA operation [RAN2, RAN1, RAN4] (This part of the work is put on hold until further checking in RAN#97)
Support only LTE sidelink CA features for NR (i.e., SL carrier (re-)selection, synchronization of aggregated carriers, handling the limited capability, power control for simultaneous sidelink TX, packet duplication)
The work is limited to FR1 licensed spectrum and ITS band in FR1.
No specific enhancements of Rel-17 sidelink features with sidelink CA support.
This feature is backwards compatible in the following regards
   A Rel-16/Rel-17 UE can receive Rel-18 sidelink broadcast/groupcast transmissions with CA for the carrier on which it receives PSCCH/PSSCH and transmits the corresponding sidelink HARQ feedback (when SL-HARQ is enabled in SCI)

In New Radio (NR), sidelink (SL) communication is introduced. A SL User Equipment (UE) could be configured with SL configured grant (CG). Two types of sidelink configured grant could be configured for the SL UE: Type 1 CG where a sidelink grant is provided by Radio Resource Control (RRC) and stored as configured sidelink grant; Type 2 CG where sidelink grant is provided by Physical Downlink Control Channel (PDCCH) and stored or cleared as configured sidelink grant based on L1 signaling indicating configured sidelink grant activation or deactivation/release. In Rel-17 and previous releases, SL UE operates on one single SL carrier frequency, and one single SL Bandwidth Part (BWP) is configured/activated at a time. The SL UE could be configured with one of the two sidelink resource allocation mode, mode 1 and mode 2. In mode 1, SL grant/SL transmission resource of the SL UE could be scheduled by a network. In mode 2, the SL UE could select SL transmission resource (in a SL resource pool). For a SL UE whose SL grant is configured/scheduled by a network, the SL UE could be configured with/provided with sidelink configured grant.

In Rel-17 and previous releases, Type 1 and/or Type 2 SL CG could be configured with the single SL BWP, and up to (a total of) 8 SL CGs (configurations) could be configured including both Type 1 and Type 2. The SL CGs could be active simultaneously on the SL BWP. Each of the SL CG configurations could be associated with an index or an identifier (e.g., sl-ConfigIndexCG).

In Rel-18, carrier aggregation (CA) support for Sidelink transmission is discussed. A SL UE could be configured/provided with more than one carrier frequency for SL communication. The SL UE could perform multiple sidelink transmissions/receptions (simultaneously) on multiple SL carrier frequencies. The multiple SL carrier frequencies could be configured by a network (via RRC signaling or via system information). The SL UE could include one SL Hybrid Automatic Repeat Request (HARQ) entity for each SL carrier frequency (with PC5 interface for transmission/reception). The SL UE could maintain a number of HARQ processes for each SL HARQ entity.

In Uu interface, uplink configured grant configuration is indicated per BWP (e.g., in BWP-UplinkDedicated), and each BWP could be configured with both Type 1 and Type 2 uplink configured grant(s). On the other hand, sidelink configured grant configuration is configured in dedicated sidelink configuration (e.g., in SL-ScheduledConfig). That is, the sidelink configured grant configuration is configured in a per-UE manner while the Uu configured grant configuration is configured in a per-BWP configuration. If SL carrier aggregation is introduced for a SL UE to operate SL transmission on multiple carrier frequencies while the network (NW) indicates or provides SL configured grant configuration via the present pre-UE method, the SL UE cannot determine on which carrier frequency the SL configured grant configuration is applied. An issue would occur as the SL transmission resources may not be scheduled as intended and could lead to SL data loss and/or conflicts between SL transmissions. In this invention, new configuration methods are introduced for SL configured grant configuration for SL and for SL carrier aggregation.

### SL Configured Grant Configuration Includes Freq-id or BWP-id

One concept or embodiment of the invention is that for each of the one or more SL configured grant configurations of a SL UE, a SL configured grant configuration could indicate or include information of a SL (carrier) frequency. A SL UE could be configured with the SL configured grant configuration by a network (e.g., via a RRC reconfiguration message or a SL scheduling configuration). The information of the SL (carrier) frequency could be an index or identity (e.g., SL-Freq-Id). Additionally and/or alternatively, the information of the SL (carrier) frequency could include an index of a carrier. Additionally and/or alternatively, the information of the SL (carrier) frequency could include an identity or an index of a (SL) BWP (e.g., sl-BWP-Id). For a SL configured grant configuration, the UE could perform SL transmission on the SL (carrier) frequency indicated in the configuration via SL resources associated with /indicated in the SL configured grant configuration and may not perform SL transmission on other SL frequencies not indicated in the configuration.

Additionally and/or alternatively, the SL configured grant configuration could indicate or include information of SL frequency and/or SL-BWP for a Type-1 SL configured grant. The information of SL frequency and/or SL BWP may not be indicated for Type-2 SL configured grant. For example, the information of the SL (carrier) frequency could be included in rrc-ConfiguredSidelinkGrant in SL-ConfiguredGrantConfig. The UE could perform/activate Type-1 SL configured grant transmission on a SL BWP of a SL frequency indicated in the information of the SL frequency (included in the SL configured grant configuration). The UE could perform/activate Type-2 SL configured grant transmission on a SL BWP of a SL frequency indicated in an activation command from the network. The activation command could be a Downlink Control Information (DCI) indicating at least a carrier index associated with SL resource(s) and activation of the Type-2 SL configured grant.

Alternatively, the SL configured grant configuration could indicate or include information of SL frequency and/or SL-BWP for both Type-1 SL configured grant and Type-2 SL configured grant. The UE could perform/activate Type-1 and Type-2 SL configured grant transmission on a SL BWP of a SL frequency indicated in the information of the SL frequency.

### Change the RRC Message Structure to Include CG Configuration in Each Bwp Configuration or Freq-configuration

Additionally and/or alternatively, the SL configured grant configuration could be included or indicated in a SL (carrier) frequency configuration (e.g., SL-FreqConfig includes one or more SL-configuredgrantconfig) or SL BWP configurations (e.g., SL-BWP-Config includes one or more SL-configuredgrantconfig). The SL configured grant configuration may not include or indicate (carrier) frequency information. The SL configured grant configuration may not be configured per-UE (e.g., one set of configurations indicated in a dedicated RRC signaling for frequency configuration of the UE). The UE could perform SL transmission via SL resources of the SL configured grant configuration on a SL (carrier) frequency indicated in the SL (carrier) frequency configuration. The network could indicate or configure dedicated SL BWP configuration containing SL configured grant configuration for the SL UE (e.g., in SL-configDedicatedNR).

Additionally and/or alternatively, the network may not indicate/provide SL configured grant configuration in sidelink communication configuration used for network scheduled NR sidelink communication (e.g., SL-ScheduledConfig). The NW may not simultaneously configure SL configured grant configuration in SL-ScheduledConfig and in (dedicated) SL-BWP-Config or (dedicated) SL-FreqConfig. When SL configured grant configuration is (dedicatedly) configured for a SL UE for more than one carrier or frequency (e.g., via SL-FreqConfig or SL-BWP-Config), the network may not provide SL configured grant configuration in SL-ScheduledConfig. The NW may not simultaneously configure SL configured grant configuration in (dedicated) SL-BWP-Config or (dedicated) SL-FreqConfig and configure sidelink communication configuration used for UE resource selection (e.g., sl-UE-SelectedConfig).

Additionally and/or alternatively, a (maximum) number of SL configured grant configuration could be configured/indicated for each SL BWP and/or each SL (carrier) frequency on which the SL UE performs SL communication (by a network). The maximum number of SL configured grant configuration could be a fixed (pre-)configured number (e.g., 8 or 16 on each SL BWP). Preferably, index or identifier (e.g., sl-ConfigIndexCG) of SL CG configurations may be independent for each SL BWP and/or each SL (carrier) frequency. Alternatively, a maximum number of SL configured grant configuration could be configured for/across all SL BWPs and/or all SL (carrier) frequencies on which the SL UE performs SL communication. For instance, when a SL configured grant configuration could indicate or include information of a SL (carrier) frequency. Preferably, index or identifier (e.g., sl-ConfigIndexCG) of SL CG configurations may be shared for/across all SL BWPs and/or all SL (carrier) frequencies. The maximum number of SL configured grant could be shared between all SL BWPs and/or SL (carrier) frequencies. The SL UE could be configured with a maximum number of SL configured grant configuration(s) across all SL BWPs (e.g., 8 or 16 configurations on all SL BWPs).

### SL BWP Configuration Indicate Index of SL Configured Grant Configuration

Additionally and/or alternatively, the network could indicate one or more SL configured grant configurations for a SL BWP and/or a SL frequency configuration. For example, the network could include an index or identity of a SL configured grant configuration (e.g., sl-ConfigIndexCG) in a SL BWP configuration (e.g., SL-FreqConfig or SL-BWP-Config).

An example text proposal of ASN.1 format for SL-BWP-Config to accommodate sidelink configured grant configuration is as follows:

Option 1 start

### - SL-BWP-Config

The IE SL-BWP-Config is used to configure the UE specific NR sidelink communication on one particular sidelink bandwidth part.

### SL-BWP-CONFIG INFORMATION ELEMENT

-- ASN1START
-- TAG-SL-BWP-CONFIG-START
SL-BWP-Config-r16 ::= SEQUENCE {
sl-BWP-Id BWP-Id,
sl-BWP-Generic-r16 SL-BWP-Generic-r16
OPTIONAL, -- Need M
sl-BWP-PoolConfig-r16 SL-BWP-PoolConfig-r16
OPTIONAL, -- Need M
...,
[[
sl-BWP-PoolConfigPS-r17 SetupRelease {SL-BWP-PoolConfigPS-r17)
OPTIONAL, -- Need M
sl-BWP-DiscPoolConfig-r17 SetupRelease {SL-BWP-DiscPoolConfig-rl7}
OPTIONAL -- Need M
]]
sl-ConfiguredGrantConfigList-r18 SL-ConfiguredGrantConfigList-r18
OPTIONAL, -- Need M
)
SL-BWP-Generic-r16 ::= SEQUENCE {
sl-BWP-rl6 BWP
OPTIONAL, -- Need M
sl-LengthSymbols-r16 ENUMERATED {sym7, sym8, sym9, sym10, sym11, sym12,
syrn13, syrn14) OPTIONAL, -- Need M
sl-StartSymbol-r16 ENUMERATED {sym0, sym1, sym2, sym3, syrn4, sym5, sym6,
sym7} OPTIONAL, -- Need M
sl-PSBCH-Config-r16 SetupRelease {SL-PSBCH-Config-r16)
OPTIONAL, -- Need M
sl-TxDirectCurrentLocation-r16 INTEGER (0..3301)
OPTIONAL, -- Need M
...
}
SL-ConfiguredGrantConfigList-r18 ::= SEQUENCE {
sl-ConfiguredGrantConfigToReleaseList-r18 SEQUENCE (SIZE (1..maxNrofCG-SL-r18) ) OF SL-
ConfigIndexCG-r18 OPTIONAL, -- Need N
sl-ConfiguredGrantConfigToAddModList-r18 SEQUENCE (SIZE (1..maxNrofCG-SL-r18) ) OF SL-
ConfiguredGrantConfig-r18 OPTIONAL -- Need N
}
-- TAG-SL-BWP-CONFIG-STOP
-- ASN1STOP

The IE SL-ConfiguredGrantConfig could specify the configured grant configuration information configured in the associated SL BWP.

Option 1 end

Option 1-2 start

### - SL-BWP-Config

The IE SL-BWP-Config is used to configure the UE specific NR sidelink communication on one particular sidelink bandwidth part.

### SL-BWP-CONFIG INFORMATION ELEMENT

-- ASN1START
-- TAG-SL-BWP-CONFIG-START
SL-BWP-Config-r16 SEQUENCE {
sl-BWP-Id BWP-Id,
sl-BWP-Generic-r16 SL-BWP-Generic-r16
OPTIONAL, -- Need M
sl-BWP-PoolConfig-r16 SL-BWP-PoolConfig-r16
OPTIONAL, -- Need M
...,
[[
sl-BWP-PoolConfigPS-r17 SetupRelease {SL-BWP-PoolConfigPS-r17)
OPTIONAL, -- Need M
sl-BWP-DiscPoolConfig-r17 SetupRelease {SL-BWP-DiscPoolConfig-r17}
OPTIONAL -- Need M
]]
sl-ConfigIndexCGList-r18 SL-ConfigIndexCGList-r18, OPTIONAL, -- Need M
}
SL-ConfigIndexCGList-r18 SEQUENCE (SIZE (1..maxNrofCG-SL-r18)) OF SL-ConfigIndexCG-r18
OPTIONAL, -- Need N
SL-BWP-Generic-r16 ::= SEQUENCE {
sl-BWP-r16 BWP
OPTIONAL, -- Need M
sl-LengthSymbols-r16 ENUMERATED {sym7, sym8, sym9, sym10, sym11, syrn12,
syrn13, syrn14) OPTIONAL, -- Need M
sl-StartSyrnbol-r16 ENUMERATED {sym0, sym1, sym2, sym3, syrn4, sym5, sym6,
sym7} OPTIONAL, -- Need M
sl-PSBCH-Config-r16 SetupRelease {SL-PSBCH-Config-r16)
OPTIONAL, -- Need M
sl-TxDirectCurrentLocation-r16 INTEGER (0..3301)
OPTIONAL, -- Need M
...
}
-- TAG-SL-BWP-CONFIG-STOP
-- ASN1STOP

Option 1-2 end

An example text proposal of ASN.1 format for SL configured grant configuration to include SL frequency/BWP information based on 38.331 (e.g., [2] 3GPP 38.331 v17.0.0) is as follows:

Option 2 start

### - SL-ConfiguredGrantConfig

The IE SL-ConfiguredGrantConfig specifies the configured grant configuration information for NR sidelink communication.

### SL-CONFIGUREDGRANTCONFIG INFORMATION ELEMENT

-- ASN1START
-- TAG-SL-CONFIGUREDGRANTCONFIG-START
SL-ConfiguredGrantConfig-r16 ::= SEQUENCE {
sl-ConfigIndexCG-r16 SL-ConfigIndexCG-r16,
sl-PeriodCG-r16 SL-PeriodCG-r16
OPTIONAL, -- Need M
sl-Freq-Id-r18 SL-Freq-Id-r18,
sl-BWP-Id BWP-Id,
SL-Freq-Id-r18 ::= INTEGER (1.. maxNrofFreqSL-r18)
sl-NrOfHARQ-Processes-r16 INTEGER (1..16)
OPTIONAL, -- Need M
sl-HARQ-ProcID-offset-r16 INTEGER (0..15)
OPTIONAL, -- Need M
sl-CG-MaxTransNumList-r16 SL-CG-MaxTransNumList-r16
OPTIONAL, -- Need M
rrc-ConfiguredSidelinkGrant-r16 SEQUENCE {
sl-TirneResourceCG-Typel-r16 INTEGER (0..496)
OPTIONAL, -- Need M
sl-StartSubchannelCG-Typel-r16 INTEGER (0..26)
OPTIONAL, -- Need M
sl-FreqResourceCG-Typel-r16 INTEGER (0..6929)
OPTIONAL, -- Need M
sl-TirneOffsetCG-Typel-r16 INTEGER (0..7999)
OPTIONAL, -- Need R
sl-NlPUCCH-AN-r16 PUCCH-ResourceId
OPTIONAL, -- Need M
sl-PSFCH-ToPUCCH-CG-Typel-r16 INTEGER (0..15)
OPTIONAL, -- Need M
sl-ResourcePoolID-r16 SL-ResourcePoolID-r16
OPTIONAL, -- Need M
sl-TirneReferenceSFN-Typel-r16 ENUMERATED {sfn512)
OPTIONAL -- Need S
}
OPTIONAL, -- Need M
...,
[[
sl-NlPUCCH-AN-Type2-r16 PUCCH-ResourceId
OPTIONAL -- Need M
]]
}
SL-ConfigIndexCG-r16 ::= INTEGER (0..maxNrofCG-SL-1-r16)
SL-CG-MaxTransNumList-r16 ::= SEQUENCE (SIZE (1..8)) OF SL-CG-MaxTransNum-r16
SL-CG-MaxTransNum-r16 ::= SEQUENCE {
sl-Priority-r16 INTEGER (1..8),
sl-MaxTransNurn-r16 INTEGER (1..32)
}
SL-PeriodCG-r16 ::= CHOICE{
sl-PeriodCGl-r16 ENUMERATED {ms100, ms200, ms300, ms400, ms500, ms600, ms700,
ms800, ms900, ms1000, spare6,
spare5, spare4, spare3, spare2, spare1},
sl-PeriodCG2-r16 INTEGER (1..99)
}
-- TAG-SL-CONFIGUREDGRANTCONFIG-STOP
-- ASN1STOP

sl-Freq-Id
This field indicates the identity of the dedicated configuration information on the carrier frequency for the associated sidelink configured grant.

sl-BWP-Id could indicate the identity of the BWP for the associated sidelink configured grant configuration.

Option 2 end

Option 2-2 start

### SL-ConfiguredGrantConfig

The IE SL-ConfiguredGrantConfig specifies the configured grant configuration information for NR sidelink communication.

### SL-CONFIGUREDGRANTCONFIG INFORMATION ELEMENT

-- ASN1START
-- TAG-SL-CONFIGUREDGRANTCONFIG-START
SL-ConfiguredGrantConfig-r16 ::= SEQUENCE {
sl-ConfigIndexCG-r16 SL-ConfigIndexCG-r16,
sl-PeriodCG-r16 SL-PeriodCG-r16
OPTIONAL, -- Need M
sl-NrOfHARQ-Processes-r16 INTEGER (1..16)
OPTIONAL, -- Need M
sl-HARQ-ProcID-offset-r16 INTEGER (0..15)
OPTIONAL, -- Need M
sl-CC-MaxTransNumList-r16 SL-CG-MaxTransNumList-r16
OPTIONAL, -- Need M
rrc-ConfiguredSidelinkGrant-r16 SEQUENCE {
sl-Freq-Id-r18 SL-Freq-Id-r18,
sl-BWP-Id BWP-Id,
sl-TirneResourceCG-Typel-r16 INTEGER (0..496)
OPTIONAL, -- Need M
sl-StartSubchannelCG-Typel-r16 INTEGER (0..26)
OPTIONAL, -- Need M
sl-FreqResourceCG-Typel-r16 INTEGER (0..6929)
OPTIONAL, -- Need M
sl-TirneOffsetCG-Typel-r16 INTEGER (0..7999)
OPTIONAL, -- Need R
sl-NlPUCCH-AN-r16 PUCCH-ResourceId
OPTIONAL, -- Need M
sl-PSFCH-ToPUCCH-CG-Typel-r16 INTEGER (0..15)
OPTIONAL, -- Need M
sl-ResourcePoolID-r16 SL-ResourcePoolID-r16
OPTIONAL, -- Need M
sl-TirneReferenceSFN-Typel-r16 ENUMERATED {sfn512)
OPTIONAL -- Need S
}
OPTIONAL, -- Need M
...,
[[
sl-N1PUCCH-AN-Type2-r16 PUCCH-ResourceId
OPTIONAL -- Need M
]]
}
SL-ConfigIndexCG-r16 ::= INTEGER (0..maxNrofCG-SL-1-r16)
SL-CG-MaxTransNumList-r16 ::= SEQUENCE (SIZE (1..8)) OF SL-CG-MaxTransNum-r16
SL-CG-MaxTransNum-r16 ::= SEQUENCE {
sl-Priority-r16 INTEGER (1..8),
sl-MaxTransNurn-r16 INTEGER (1..32)
}
SL-PeriodCG-r16 ::= CHOICE{
sl-PeriodCGl-r16 ENUMERATED {ms100, ms200, ms300, ms400, ms500, ms600, ms700,
ms800, ms900, ms1000, spare6,
spare5, spare4, spare3, spare2, spare1},
sl-PeriodCG2-r16 INTEGER (1..99)
}
SL-Freq-Id-r18 ::= INTEGER (1.. maxNrofFreqSL-r18)
sl-BWP-Id ::= INTEGER (1.. maxNrofBWPSL-r18)
-- TAG-SL-CONFIGUREDGRANTCONFIG-STOP
-- ASN1STOP

sl-Freq-ld
This field indicates the identity of the dedicated configuration information on the carrier frequency for the associated sidelink configured grant.

sl-BWP-Id could indicate the identity of the BWP for the associated sidleink configured grant configuration.

Option 2-2 end

Additionally and/or alternatively, the SL UE could be configured with one or more sidelink scheduling configurations (e.g., multiple resource allocation mode 1 configurations for each SL carrier/frequency). The SL UE could be configured with a list indicating the one or more sidelink scheduling configurations. Each of the one or more sidelink scheduling configurations could be associated with a SL carrier or a SL (carrier) frequency (e.g., SL-Freq-Id or SL-Freq-Config) or a SL BWP. Each of the one or more sidelink scheduling configurations could contain or indicate one or more SL configured grant configurations. Each of the one or more SL configured grant configurations could be associated with one of the corresponding one or more sidelink scheduling configurations and the corresponding SL carrier or the SL (carrier) frequency.

An example of indicating multiple scheduling configurations associated with different SL frequencies in a list is shown below:

Option 3 start

### SL-ConfigDedicatedNR

The IE SL-ConfigDedicatedNR specifies the dedicated configuration information for NR sidelink communication.

### SL-CONFIGDEDICATEDNR INFORMATION ELEMENT

-- ASN1START
-- TAG-SL-CONFIGDEDICATEDNR-START
SL-ConfigDedicatedNR-r16 ::= SEQUENCE {
sl-PHY-MAC-RLC-Config-r16 SL-PHY-MAC-RLC-Config-
r16 OPTIONAL, -- Need M
sl-RadioBearerToReleaseList-r16 SEQUENCE (SIZE (1..maxNrofSLRB-r16)) OF SLRB-Uu-ConfigIndex-
r16 OPTIONAL, -- Need N
sl-RadioBearerToAddModList-r16 SEQUENCE (SIZE (1..maxNrofSLRB-r16)) OF SL-RadioBearerConfig-
r16 OPTIONAL, -- Need N
sl-MeasConfigInfoToReleaseList-r16 SEQUENCE (SIZE (1..maxNrofSL-Dest-r16)) OF SL-
DestinationIndex-r16 OPTIONAL, -- Need N
sl-MeasConfigInfoToAddModList-r16 SEQUENCE (SIZE (1..maxNrofSL-Dest-r16)) OF SL-MeasConfigInfo-
r16 OPTIONAL, -- Need N
t400-r16 ENUMERATED {ms100, ms200, ms300, ms400, ms600, ms1000,
ms1500, ms2000} OPTIONAL, -- Need M
...,
[[
sl-PHY-MAC-RLC-Config-v1700 SL-PHY-MAC-RLC-Config-
v1700 OPTIONAL, -- Need M
sl-DiscConfig-r17 SetupRelease { SL-DiscConfig-
rl7} OPTIONAL, -- Need M
sl-RLC-ChannelToReleaseList-r17 SEQUENCE (SIZE (1..maxSL-LCID-r16)) OF SL-RLC-ChannelID-
r17 OPTIONAL, -- Cond L2U2N
s1-RLC-ChannelToAddModList-r17 SEQUENCE (SIZE (l..maxSL-LCID-r16)) OF SL-RLC-ChannelConfig-
r17 OPTIONAL -- Cond L2U2N
]]
}
SL-DestinationIndex-r16 ::= INTEGER (0..maxNrofSL-Dest-1-r16)
SL-PHY-MAC-RLC-Config-r16::= SEQUENCE {
sl-ScheduledConfig-r16 SetupRelease { SL-ScheduledConfig-r16
} OPTIONAL, -- Need M
sl-UE-SelectedConfig-r16 SetupRelease { SL-UE-SelectedConfig-r16
} OPTIONAL, -- Need M
sl-FreqInfoToReleaseList-r16 SEQUENCE (SIZE (1..maxNrofFreqSL-r16)) OF SL-Freq-Id-
r16 OPTIONAL, -- Need N
sl-FreqInfoToAddModList-r16 SEQUENCE (SIZE (l..maxNrofFreqSL-r16)) OF SL-FreqConfig-
r16 OPTIONAL, -- Need N
sl-RLC-BearerToReleaseList-r16 SEQUENCE (SIZE (1..maxSL-LCID-r16)) OF SL-RLC-
BearerConfigIndex-r16 OPTIONAL, -- Need N
sl-RLC-BearerToAddModList-r16 SEQUENCE (SIZE (1..maxSL-LCID-r16)) OF SL-RLC-BearerConfig-
r16 OPTIONAL, -- Need N
sl-MaxNumConsecutiveDTX-r16 ENUMERATED {n1, n2, n3, n4, n6, n8, n16,
n32} OPTIONAL, -- Need M
sl-CSI-Acquisition-r16 ENUMERATED
{enabled} OPTIONAL, -- Need R
sl-CSI-SchedulingRequestId-r16 SetupRelease
(SchedulingRequestId} OPTIONAL, -- Need M
sl-SSB-PriorityNR-r16 INTEGER
(1..8) OPTIONAL, -- Need R
networkControlledSyncTx-r16 ENUMERATED {on,
off} OPTIONAL -- Need M
sl-ScheduledConfig-r18 SetupRelease { SL-ScheduledConfigList-r18
} OPTIONAL -- Need M
}
SL-ScheduledConfigList-r18 SEQUENCE (SIZE (l..maxNrofFreqSL-r16)) OF SL-
ScheduledConfig-r16 OPTIONAL, -- Need N
//This list is one-to-one mapping to sl-FreqInfoToAddModList-r16, and once SL-Freq-Id-r16 in sl-
FreqInfoToReleaseList-r16 for release, corresponding entry in SL-ScheduledConfigList-r18 is also
released.

Option 3 end

For the concepts and examples disclosed above and herein, the following aspects and embodiments can be implemented, performed, added, or included. All concepts, examples, and embodiments herein could be combined into one or more new concepts.

The SL UE could be configured with or operating in SL resource allocation mode 1. The SL UE may not be configured with or operating in SL resource allocation mode 2.

The (one or more) SL configured grant configurations could be Configured grant type 1. SL resources associated with the SL configured grant configuration could be configured by NW via RRC message.

Alternatively, the SL configured grant configuration could be Configured grant type 2. SL resources associated with the SL configured grant configuration could be indicated by a DCI.

The (carrier) frequency information could be identity or index of a (carrier) frequency of BWP (of SL) and/or identity or index of a (carrier) frequency (of SL).

The frequency information may not be a frequency resource location, or a sub-channel information, or a HARQ resource, or a resource pool indication for a CG.

The SL frequency and/or SL BWP configuration could be provided/indicated to the UE via a first dedicated signaling by a gNB (network). The one or more SL configured grant configurations could be configured via a second dedicated signaling. The first dedicated signaling and the second dedicated signaling could be transmitted in the same RRC message. Alternatively, the first dedicated signaling and the second dedicated signaling could be transmitted via different RRC message(s).

For the concepts and examples disclosed above, the following aspects and embodiments can be implemented, performed, added, or included. All concepts, examples, and embodiments herein could be combined into one or more new concepts.

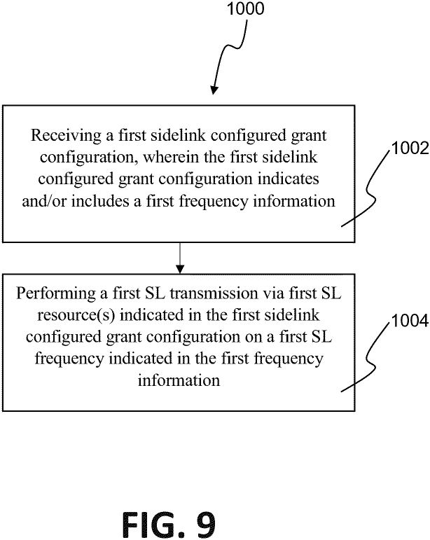

Referring to FIG. 9, with this and other concepts, systems, and methods of the present invention, a method 1000 for a first device in a wireless communication system comprises receiving a first sidelink configured grant configuration, wherein the first sidelink configured grant configuration indicates and/or includes a first frequency information (step 1002), and performing a first SL transmission via first SL resource(s) indicated in the first sidelink configured grant configuration on a first SL frequency indicated in the first frequency information (step 1004).

In various embodiment, the method further comprises receiving a second sidelink configured grant configuration, wherein the second sidelink configured grant configuration indicates and/or includes a second frequency information, and performing a second SL transmission via second SL resource(s) indicated in the second sidelink configured grant configuration on a second SL frequency indicated in the second frequency information.

In various embodiments, the first and the second sidelink configured grant configurations are transmitted in a same RRC message.

In various embodiments, the first and the second sidelink configured grant configurations are transmitted in different RRC messages.

In various embodiments, the frequency information indicates an identity or an index associated with a SL frequency.

In various embodiments, the frequency information indicates an identity or an index associated with a SL bandwidth part.

In various embodiments, the first and the second SL frequencies are (different) SL carriers or SL BWPs.

In various embodiments, the first and the second sidelink configured grant configurations are Type 1 Configured grants.

In various embodiments, the first and the second sidelink configured grant configurations are Type 2 Configured grants.

Referring back to FIGS. 3 and 4, in one or more embodiments from the perspective of a first device, the device 300 includes a program code 312 stored in memory 310 of the transmitter. The CPU 308 could execute program code 312 to: (i) receive a first sidelink configured grant configuration, wherein the first sidelink configured grant configuration indicates and/or includes a first frequency information; and (ii) perform a first SL transmission via first SL resource(s) indicated in the first sidelink configured grant configuration on a first SL frequency indicated in the first frequency information. Moreover, the CPU 308 can execute the program code 312 to perform all of the described actions, steps, and methods described above, below, or otherwise herein.

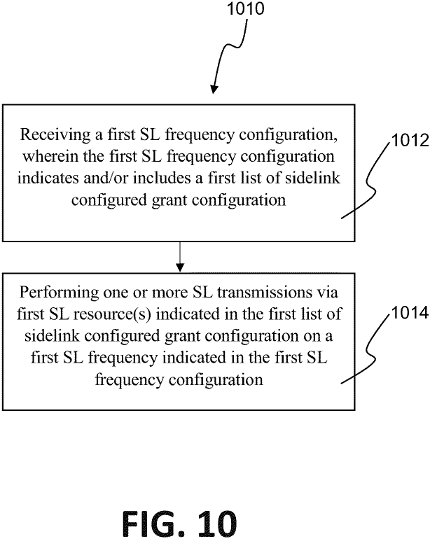

Referring to FIG. 10, with this and other concepts, systems, and methods of the present invention, a method 1010 for a first device in a wireless communication system comprises receiving a first SL frequency configuration, wherein the first SL frequency configuration indicates and/or includes a first list of sidelink configured grant configuration (step 1012), and performing one or more SL transmissions via first SL resource(s) indicated in the first list of sidelink configured grant configuration on a first SL frequency indicated in the first SL frequency configuration (step 1014).

In various embodiments, the method further comprises receiving a second SL frequency configuration, wherein the second SL frequency configuration indicates and/or includes a second list of sidelink configured grant configuration, and performing one or more SL transmissions via second SL resource(s) indicated in the second list of sidelink configured grant configuration on a second SL frequency indicated in the second SL frequency configuration.

In various embodiments, the first and the second SL frequences are (different) SL carriers or SL BWPs.

In various embodiments, the first list of sidelink configured grant configuration includes and/or indicates one or more first sidelink configured grant configurations.

In various embodiments, the second list of sidelink configured grant configuration includes and/or indicates one or more second sidelink configured grant configurations.

In various embodiments, the one or more first sidelink configured grant configurations does not indicate or include frequency information associated with the first frequency.

In various embodiments, the one or more second sidelink configured grant configurations does not indicate or include frequency information associated with the second frequency.

Referring back to FIGS. 3 and 4, in one or more embodiments from the perspective of a first device, the device 300 includes a program code 312 stored in memory 310 of the transmitter. The CPU 308 could execute program code 312 to: (i) receive a first SL frequency configuration, wherein the first SL frequency configuration indicates and/or includes a first list of sidelink configured grant configuration; and (ii) perform one or more SL transmissions via first SL resource(s) indicated in the first list of sidelink configured grant configuration on a first SL frequency indicated in the first SL frequency configuration. Moreover, the CPU 308 can execute the program code 312 to perform all of the described actions, steps, and methods described above, below, or otherwise herein.

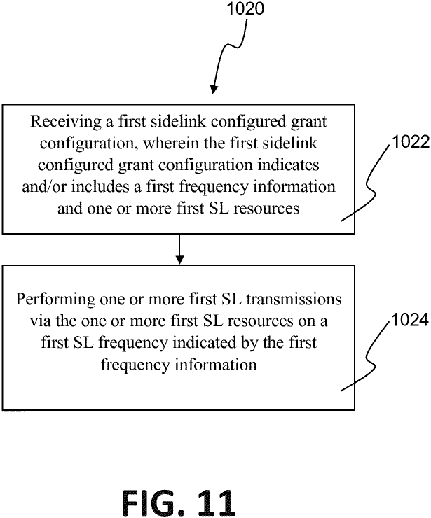

Referring to FIG. 11, with this and other concepts, systems, and methods of the present invention, a method 1020 for a first device in a wireless communication system comprises receiving a first sidelink configured grant configuration, wherein the first sidelink configured grant configuration indicates and/or includes a first frequency information and one or more first SL resources (step 1022), and performing one or more first SL transmissions via the one or more first SL resources on a first SL frequency indicated by the first frequency information (step 1024).

In various embodiments, the method further comprises receiving a second sidelink configured grant configuration, wherein the second sidelink configured grant configuration indicates and/or includes a second frequency information, receiving a signaling from a network node, wherein the signaling indicates second SL resource(s), wherein the signaling is used for activating the second sidelink configured grant configuration, and performing a second SL transmission via the second SL resource(s) on a second SL frequency indicated by the second frequency information.

In various embodiments, the second sidelink configured grant configuration is a Type 2 configured grant, and/or the second frequency information indicates an identity or an index associated with the second SL frequency, and/or the second SL frequency is a second carrier frequency and/or a second SL BWP utilized for sidelink.

In various embodiments, the method further comprises receiving a second sidelink configured grant configuration, receiving a signaling from a network node, wherein the signaling indicates a second frequency information and second SL resource(s), wherein the signaling is used for activating the second SL configured grant configuration, and performing a second SL transmission via the second SL resource(s) on a second SL frequency indicated by the second frequency information.

In various embodiments, the second sidelink configured grant configuration does not indicate and/or include the second frequency information.

In various embodiments, the second sidelink configured grant configuration is a Type 2 configured grant, and/or the second frequency information indicates identity or index associated with the second SL frequency, and/or the second SL frequency is a second carrier frequency and/or a second SL BWP utilized for sidelink.

In various embodiments, the first sidelink configured grant configuration is a Type 1 Configured grant, and/or the first frequency information indicates identity or index associated with the first SL frequency, and/or the first SL frequency is a first carrier frequency and/or a first SL BWP utilized for sidelink.

In various embodiments, the first and the second SL frequencies are (different) SL carriers or SL BWPs.

Referring back to FIGS. 3 and 4, in one or more embodiments from the perspective of a first device, the device 300 includes a program code 312 stored in memory 310 of the transmitter. The CPU 308 could execute program code 312 to: (i) receive a first sidelink configured grant configuration, wherein the first sidelink configured grant configuration indicates and/or includes a first frequency information and one or more first SL resources; and (ii) perform one or more first SL transmissions via the one or more first SL resources on a first SL frequency indicated by the first frequency information. Moreover, the CPU 308 can execute the program code 312 to perform all of the described actions, steps, and methods described above, below, or otherwise herein.

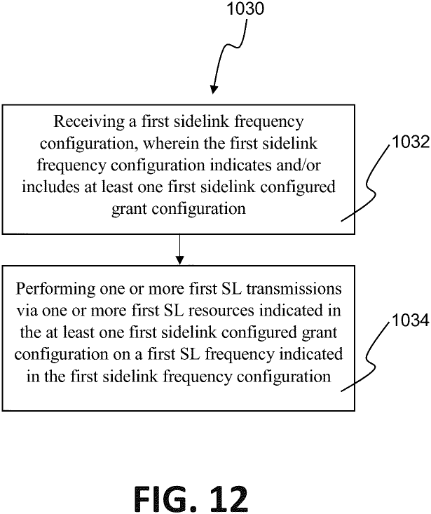

Referring to FIG. 12, with this and other concepts, systems, and methods of the present invention, a method 1030 for a first device in a wireless communication system comprises receiving a first sidelink frequency configuration, wherein the first sidelink frequency configuration indicates and/or includes at least one first sidelink configured grant configuration (step 1032), and performing one or more first SL transmissions via one or more first SL resources indicated in the at least one first sidelink configured grant configuration on a first SL frequency indicated in the first sidelink frequency configuration (step 1034).

In various embodiments, when the first device has multiple SL frequency configurations comprising the first SL frequency configuration, the first SL frequency configuration indicates and/or includes the at least one first sidelink configured grant configuration, and/or when the first device has only one SL frequency configuration, which is the first SL frequency configuration, the at least one first sidelink configured grant configuration is not included or indicated in the first SL frequency configuration, and/or when the first device has only one SL frequency configuration, which is the first SL frequency configuration, the at least one first sidelink configured grant configuration is included or indicated in a SL configuration other than the first SL frequency configuration.

Referring back to FIGS. 3 and 4, in one or more embodiments from the perspective of a first device, the device 300 includes a program code 312 stored in memory 310 of the transmitter. The CPU 308 could execute program code 312 to: (i) receive a first sidelink frequency configuration, wherein the first sidelink frequency configuration indicates and/or includes at least one first sidelink configured grant configuration; and (ii) perform one or more first SL transmissions via one or more first SL resources indicated in the at least one first sidelink configured grant configuration on a first SL frequency indicated in the first sidelink frequency configuration. Moreover, the CPU 308 can execute the program code 312 to perform all of the described actions, steps, and methods described above, below, or otherwise herein.

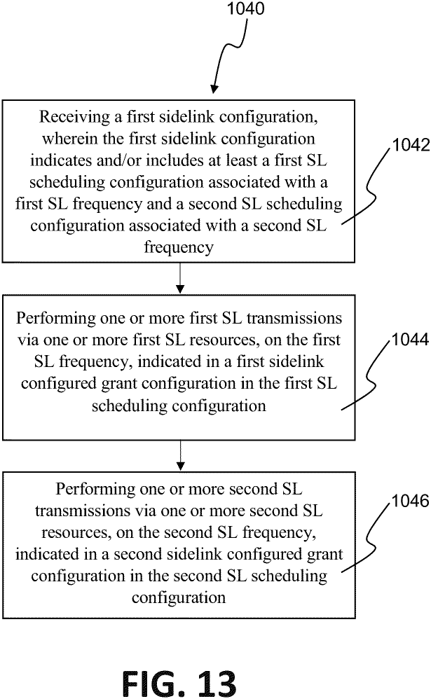

Referring to FIG. 13, with this and other concepts, systems, and methods of the present invention, a method 1040 for a first device in a wireless communication system comprises receiving a first sidelink configuration, wherein the first sidelink configuration indicates and/or includes at least a first SL scheduling configuration associated with a first SL frequency and a second SL scheduling configuration associated with a second SL frequency (step 1042), performing one or more first SL transmissions via one or more first SL resources, on the first SL frequency, indicated in a first sidelink configured grant configuration in the first SL scheduling configuration (step 1044), and performing one or more second SL transmissions via one or more second SL resources, on the second SL frequency, indicated in a second sidelink configured grant configuration in the second SL scheduling configuration (step 1046).

In various embodiments, the first sidelink configuration indicates and/or includes at least a first SL frequency configuration and a second SL frequency configuration, and the first SL frequency configuration indicates the first SL frequency and the second SL frequency configuration indicates the second SL frequency.

In various embodiments, a number of SL scheduling configurations is the same as a number of SL frequency configurations for indicating SL frequency, and/or association between SL scheduling configuration and SL frequency is based on one-to-one mapping between SL scheduling configuration and SL frequency. In various embodiments, the method further includes: the first SL configuration indicates and/or includes multiple SL scheduling configurations and multiple SL frequency configurations. The number of the multiple SL scheduling configurations is the same as the number of the multiple SL frequency configurations used to indicate multiple SL frequencies, and/or association between the multiple SL scheduling configurations and the multiple SL frequencies is based on one-to-one mapping between the multiple SL scheduling configurations and the multiple SL frequencies.

Referring back to FIGS. 3 and 4, in one or more embodiments from the perspective of a first device, the device 300 includes a program code 312 stored in memory 310 of the transmitter. The CPU 308 could execute program code 312 to: (i) receive a first sidelink configuration, wherein the first sidelink configuration indicates and/or includes at least a first SL scheduling configuration associated with a first SL frequency and a second SL scheduling configuration associated with a second SL frequency; (ii) perform one or more first SL transmissions via one or more first SL resources, on the first SL frequency, indicated in a first sidelink configured grant configuration in the first SL scheduling configuration; and (iii) perform one or more second SL transmissions via one or more second SL resources, on the second SL frequency, indicated in a second sidelink configured grant configuration in the second SL scheduling configuration. Moreover, the CPU 308 can execute the program code 312 to perform all of the described actions, steps, and methods described above, below, or otherwise herein.

Any combination of the above concepts or teachings can be jointly combined or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a first device, comprising:
receiving a first sidelink (SL) configured grant configuration, wherein the first SL configured grant configuration indicates and/or includes a first frequency information and one or more first SL resources; and
performing one or more first SL transmissions via the one or more first SL resources on a first SL frequency indicated by the first frequency information.

2. The method of claim 1, further comprising:
receiving a second SL configured grant configuration, wherein the second SL configured grant configuration indicates and/or includes a second frequency information;
receiving a signaling from a network node, wherein the signaling indicates one or more second SL resources, wherein the signaling is used for activating the second SL configured grant configuration; and
performing one or more second SL transmissions via the one or more second SL resources on a second SL frequency indicated by the second frequency information.

3. The method of claim 2, wherein the second SL configured grant configuration is a Type 2 configured grant.

4. The method of claim 2, wherein the second frequency information indicates an identity or an index associated with the second SL frequency; and/or
wherein the second SL frequency is a second carrier frequency and/or a second SL Bandwidth Part (BWP) utilized for sidelink; and/or
wherein the first and the second SL frequencies are different SL carriers or SL BWPs.

5. The method of claim 1, further comprising:
receiving a second SL configured grant configuration;
receiving a signaling from a network node, wherein the signaling indicates a second frequency information and one or more second SL resources, wherein the signaling is used for activating the second SL configured grant configuration; and
performing one or more second SL transmissions via the one or more second SL resources on a second SL frequency indicated by the second frequency information.

6. The method of claim 5, wherein the second SL configured grant configuration does not indicate and/or include the second frequency information.

7. The method of claim 5, wherein the second SL configured grant configuration is a Type 2 configured grant.

8. The method of claim 5, wherein the second frequency information indicates an identity or an index associated with the second SL frequency; and/or
wherein the second SL frequency is a second carrier frequency and/or a second SL Bandwidth Part (BWP) utilized for sidelink; and/or
wherein the first and the second SL frequencies are different SL carriers or SL BWPs.

9. The method of claim 1, wherein the first SL configured grant configuration is a Type 1 Configured grant.

10. The method of claim 1, wherein the first frequency information indicates identity or index associated with the first SL frequency; and/or
wherein the first SL frequency is a first carrier frequency and/or a first SL Bandwidth Part (BWP) utilized for sidelink.

11. A method of a first device, comprising:
receiving a first sidelink (SL) frequency configuration, wherein the first SL frequency configuration indicates and/or includes at least one first SL configured grant configuration; and
performing one or more first SL transmissions via one or more first SL resources indicated in the at least one first SL configured grant configuration on a first SL frequency indicated in the first SL frequency configuration.

12. The method of claim 11, wherein when the first device has multiple SL frequency configurations comprising the first SL frequency configuration, the first SL frequency configuration indicates and/or includes the at least one first SL configured grant configuration.

13. The method of claim 11, wherein when the first device has only one SL frequency configuration, which is the first SL frequency configuration, the at least one first SL configured grant configuration is not included or indicated in the first SL frequency configuration.

14. The method of claim 11, wherein when the first device has only one SL frequency configuration, which is the first SL frequency configuration, the at least one first SL configured grant configuration is included or indicated in a SL configuration other than the first SL frequency configuration.

15. A method of a first device, comprising:
receiving a first sidelink (SL) configuration, wherein the first SL configuration indicates and/or includes at least a first SL scheduling configuration associated with a first SL frequency and a second SL scheduling configuration associated with a second SL frequency;
performing one or more first SL transmissions via one or more first SL resources, on the first SL frequency, indicated in a first SL configured grant configuration in the first SL scheduling configuration; and
performing one or more second SL transmissions via one or more second SL resources, on the second SL frequency, indicated in a second SL configured grant configuration in the second SL scheduling configuration.

16. The method of claim 15, wherein the first SL configuration indicates and/or includes at least a first SL frequency configuration and a second SL frequency configuration; and
wherein the first SL frequency configuration indicates the first SL frequency and the second SL frequency configuration indicates the second SL frequency.

17. The method of claim 15, wherein a number of SL scheduling configurations is the same as a number of SL frequency configurations for indicating SL frequency; and/or
wherein association between SL scheduling configuration and SL frequency is based on one-to-one mapping between SL scheduling configuration and SL frequency.
